(19) United States
(12) Patent Application Publication
(10) Pub. No.: US 2026/0222538 A1
(43) Pub. Date: Jul. 30, 2026

(54) VIDEO ENCODING/DECODING METHOD AND RECORDING MEDIUM FOR STORING BITSTREAM

(71) Applicant: KT CORPORATION, Gyeonggi-do (KR)

(72) Inventor: Sung Won LIM, Gyeonggi-do (KR)

(73) Assignee: KT CORPORATION, Gyeonggi-do (KR)

(21) Appl. No.: 19/147,829

(22) PCT Filed: Jan. 16, 2024
(86) PCT No.: PCT/KR2024/000793

§ 371 Date: Jul. 14, 2025

(30) Foreign Application Priority Data
Jan. 16, 2023 (KR) 1020230006363

(51) Int. Cl. H04N 19/105; H04N 13/161; H04N 19/159; H04N 19/176; H04N 19/513

(52) U.S. Cl. CPC H04N 19/105; H04N 13/161; H04N 19/159; H04N 19/176; H04N 19/521

(57) ABSTRACT

A method of decoding a video according to the present disclosure comprises decoding a motion vector difference value of a current block from a bitstream; and obtaining, by using the motion vector of the current block, a prediction sample for the current block. At this time, when the motion vector precision for the current block is derived on a decoder side, the motion vector may be derived by using one of a plurality of motion vector difference value candidates.

### TECHNICAL FIELD

The present disclosure relates to a method and a device for processing a video signal.

### BACKGROUND ART

Recently, demands for high-resolution and high-quality images such as HD (High Definition) images and UHD (Ultra High Definition) images have increased in a variety of application fields. As image data becomes high-resolution and high-quality, the volume of data relatively increases compared to the existing image data, so when image data is transmitted by using media such as the existing wire and wireless broadband circuit or is stored by using the existing storage medium, expenses for transmission and expenses for storage increase. High efficiency image compression technologies may be utilized to resolve these problems which are generated as image data becomes high-resolution and high-quality.

There are various technologies such as an inter prediction technology which predicts a pixel value included in a current picture from a previous or subsequent picture of a current picture with an image impression technology, an intra prediction technology which predicts a pixel value included in a current picture by using pixel information in a current picture, an entropy encoding technology which assigns a short sign to a value with high appearance frequency and assigns a long sign to a value with low appearance frequency and so on, and image data may be effectively compressed and transmitted or stored by using these image compression technologies.

On the other hand, as demands for a high-resolution image have increased, demands for stereo-scopic image contents have increased as a new image service. A video compression technology for effectively providing high-resolution and ultra high-resolution stereo-scopic image contents has been discussed.

### DISCLOSURE

### Technical Problem

The present disclosure is to provide a method for replacing a bypass coding engine with a general coding engine when encoding/decoding a motion vector difference value and a device for performing the same.

The present disclosure is to provide a method for deriving a motion vector difference value based on a template matching cost and a device for performing the same.

Technical effects of the present disclosure may be non-limited by the above-mentioned technical effects, and other unmentioned technical effects may be clearly understood from the following description by those having ordinary skill in the technical field to which the present disclosure pertains.

### Technical Solution

An image decoding method according to the present disclosure may include obtaining a motion vector difference value of a current block; obtaining a motion vector of the current block based on the motion vector difference value; and obtaining a prediction sample for the current block based on the motion vector. In this case, a current motion vector difference value may be obtained based on information representing whether a prediction value for an empty bin in a bin string corresponding to the motion vector difference value is correct.

In an image decoding method according to the present disclosure, bins excluding the empty bin in the bin string may be decoded without using probability information.

In an image decoding method according to the present disclosure, the information representing whether a prediction value for the empty bin is correct may be decoded by using probability information.

In an image decoding method according to the present disclosure, an occurrence probability of a value representing that the prediction value is correct may be set to be higher than an occurrence probability of a value representing that the prediction value is not correct.

In an image decoding method according to the present disclosure, a candidate having the smallest template matching cost among a plurality of motion vector difference value candidates may be selected, and a value at a position corresponding to the empty bin in a bin string of a selected candidate may be set as a prediction value of the empty bin.

In an image decoding method according to the present disclosure, the plurality of motion vector difference value candidates may include a first motion vector difference value candidate corresponding to a case in which a value of the empty bin in the bin string is 0 and a second motion vector difference value candidate corresponding to a case in which a value of the empty bin in the bin string is 1.

In an image decoding method according to the present disclosure, the empty bin may correspond to a position of a least significant bit (LSB) or a most significant bit (MSB) of the bin string.

In an image decoding method according to the present disclosure, a position of the empty bin in the bin string may be adaptively determined based on at least one of motion vector precision of the current block or whether bilateral prediction is applied to the current block.

In an image decoding method according to the present disclosure, when the information indicates that the prediction value is correct, a value at a position of the empty bin in the bin string may be determined as the same value as the prediction value.

In an image decoding method according to the present disclosure, when the information indicates that the prediction value is not correct, a value at a position of the empty bin in the empty string may be determined as a value different from the prediction value.

An image encoding method according to the present disclosure may include obtaining a prediction sample for the current block based on a motion vector of a current block; obtaining a motion vector difference value of a current block by subtracting a motion vector prediction value from the motion vector; and encoding the motion vector difference value. In this case, encoding the motion vector difference value may include encoding information representing whether a prediction value for an empty bin in a bin string corresponding to the motion vector difference value is correct.

The features briefly summarized above for the present disclosure are just an exemplary aspect of a detailed description for the present disclosure described below, and do not limit the scope of the present disclosure.

### Technical Effect

According to the present disclosure, in encoding/decoding a motion vector difference value, a bypass coding engine may be replaced with a general coding engine, improving encoding/decoding efficiency.

According to the present disclosure, a method for predicting a motion vector difference value on a decoder side based on a template matching cost may be provided.

Effects obtainable from the present disclosure are not limited to the above-mentioned effects and other unmentioned effects may be clearly understood from the following description by those having ordinary skill in the technical field to which the present disclosure pertains.

### BRIEF DESCRIPTION OF DRAWINGS

FIG. 1 is a block diagram showing an image encoding device according to an embodiment of the present disclosure.

FIG. 2 is a block diagram showing an image decoding device according to an embodiment of the present disclosure.

FIG. 3 shows an example in which motion estimation is performed.

FIGS. 4 and 5 show an example in which a prediction block of a current block is generated based on motion information generated through motion estimation.

FIG. 6 shows a position referred to for deriving a motion vector prediction value.

FIG. 7 is a diagram for describing a template-based motion estimation method.

FIG. 8 shows examples in which a template is configured.

FIG. 9 is a diagram for describing a motion estimation method based on a bilateral matching method.

FIG. 10 is a diagram for describing a motion estimation method based on a unilateral matching method.

FIG. 11 shows an example in which decoding is performed in a unit of a bin.

FIG. 12 represents a decoding method based on a general coding engine.

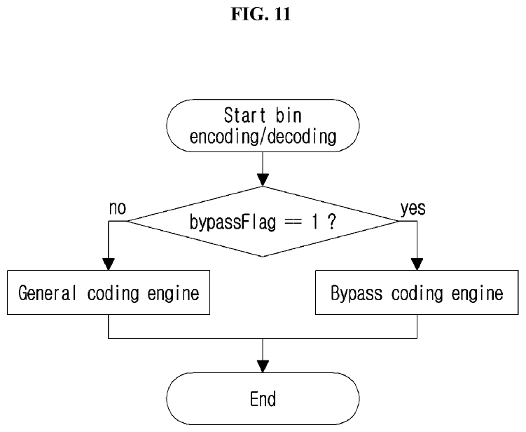

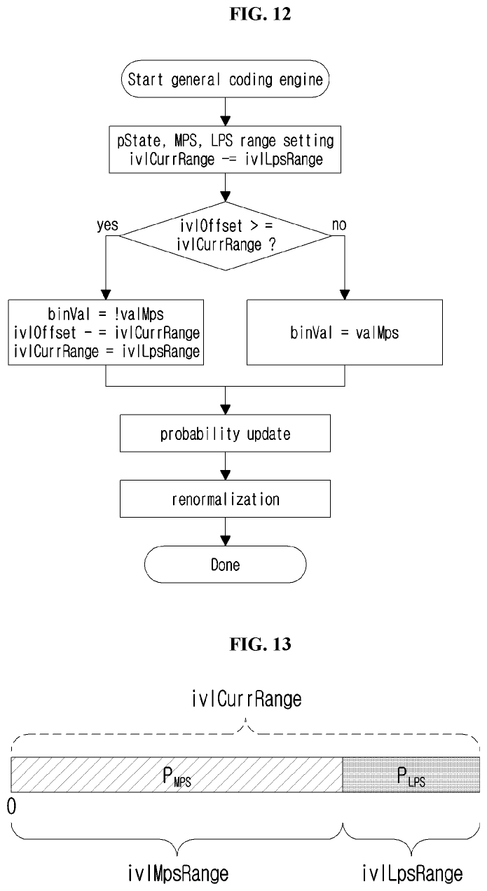

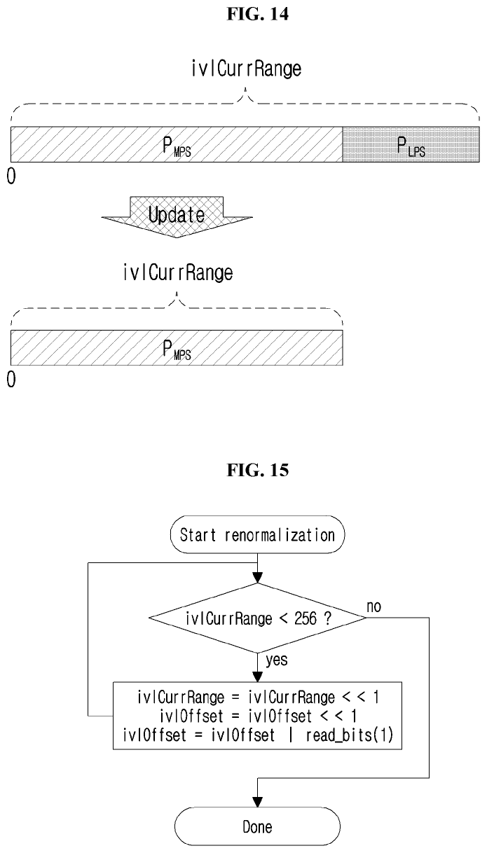

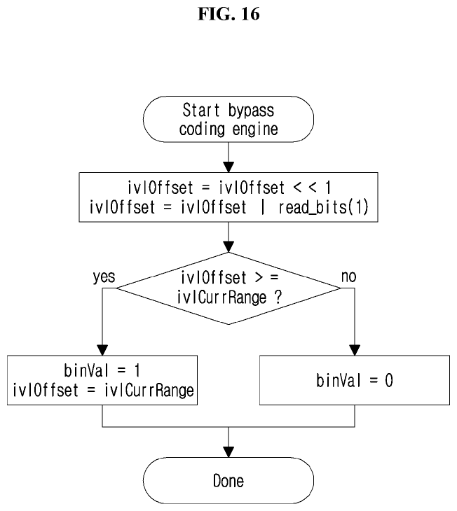

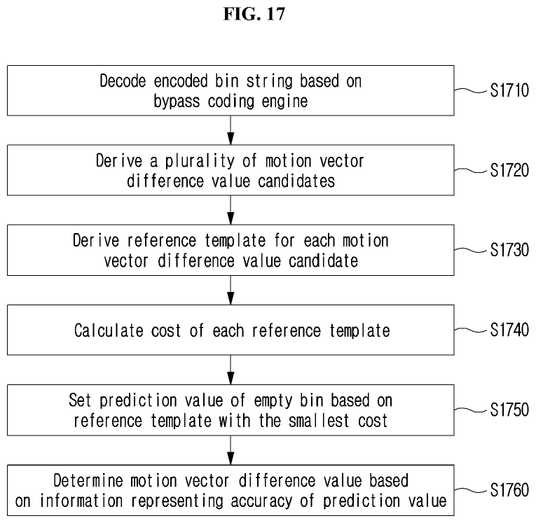

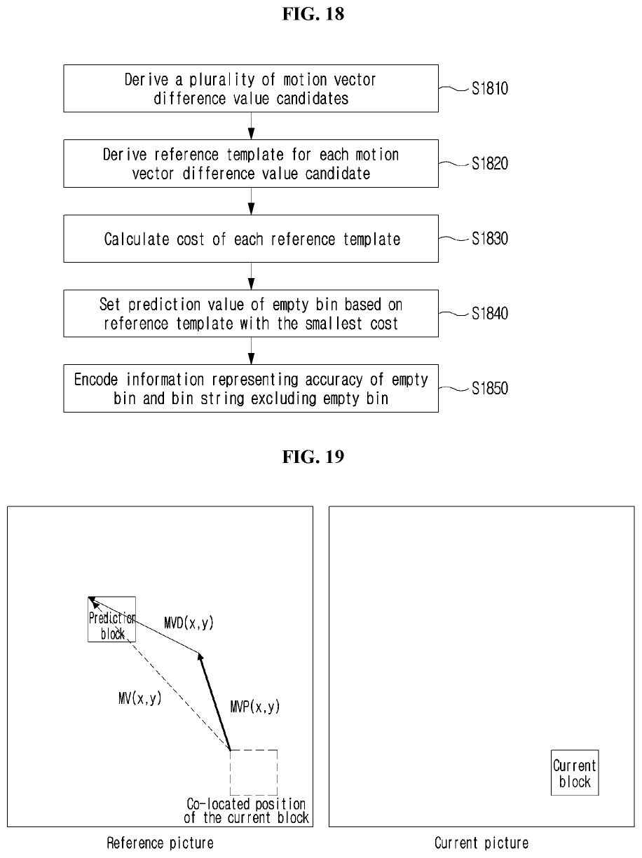

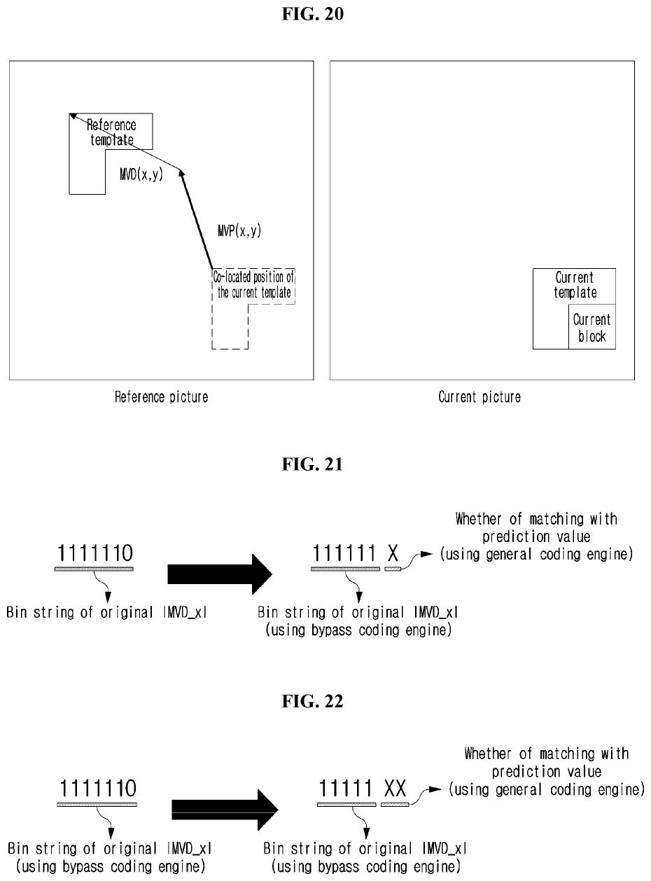

FIGS. 11 and 12 are a diagram for describing a process of encoding and decoding a motion vector difference value when an AMVR method is applied, respectively.

FIG. 13 schematizes a MPS occurrence probability and a LPS occurrence probability within a predetermined range.

FIG. 14 represents the update aspect of a variable ivlCurrRange.

FIG. 15 is a flowchart showing a renormalization process.

FIG. 16 represents a decoding process based on a bypass coding engine.

FIGS. 17 and 18 are a flowchart of a method for encoding/decoding a motion vector difference value according to an embodiment of the present disclosure.

FIG. 19 is a diagram illustrating a motion vector expressed as a sum of a motion vector prediction value and a motion vector difference value.

FIG. 20 represents an example in which a reference template is derived based on a motion vector derived by combining a motion vector difference value candidate and a motion vector prediction value.

FIG. 21 illustrates an aspect of encoding/decoding the absolute value of a motion vector difference value.

FIG. 22 represents an example in which a plurality of bins are set as an empty bin.

### MODE FOR INVENTION

As the present disclosure may make various changes and have several embodiments, specific embodiments will be illustrated in a drawing and described in detail. But, it is not intended to limit the present disclosure to a specific embodiment, and it should be understood that it includes all changes, equivalents or substitutes included in an idea and a technical scope for the present disclosure. A similar reference numeral was used for a similar component while describing each drawing.

A term such as first, second, etc. may be used to describe various components, but the components should not be limited by the terms. The terms are used only to distinguish one component from other components. For example, without going beyond a scope of a right of the present disclosure, a first component may be referred to as a second component and similarly, a second component may be also referred to as a first component. A term of and/or includes a combination of a plurality of relative entered items or any item of a plurality of relative entered items.

When a component is referred to as being “linked” or “connected” to other component, it should be understood that it may be directly linked or connected to that other component, but other component may exist in the middle. On the other hand, when a component is referred to as being “directly linked” or “directly connected” to other component, it should be understood that other component does not exist in the middle.

As terms used in this application are just used to describe a specific embodiment, they are not intended to limit the present disclosure. Expression of the singular includes expression of the plural unless it clearly has a different meaning contextually. In this application, it should be understood that a term such as “include” or “have”, etc. is to designate the existence of characteristics, numbers, steps, motions, components, parts or their combinations entered in the specification, but is not to exclude a possibility of addition or existence of one or more other characteristics, numbers, steps, motions, components, parts or their combinations in advance.

Hereinafter, referring to the attached drawings, a desirable embodiment of the present disclosure will be described in more detail. Hereinafter, the same reference numeral is used for the same component in a drawing and an overlapping description for the same component is omitted.

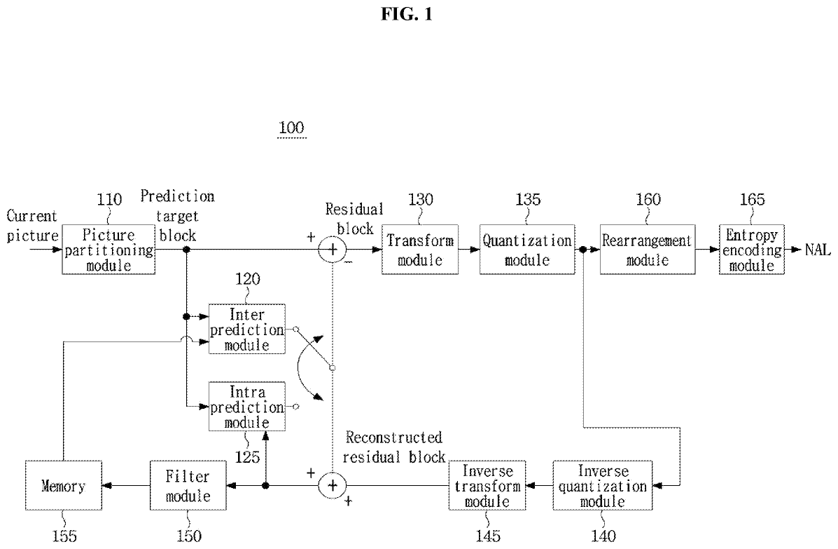

FIG. 1 is a block diagram showing an image encoding device according to an embodiment of the present disclosure.

Referring to FIG. 1, an image encoding device 100 may include a picture partitioning unit 110, prediction units 120 and 125, a transform unit 130, a quantization unit 135, a rearrangement unit 160, an entropy encoding unit 165, a dequantization unit 140, an inverse-transform unit 145, a filter unit 150, and a memory 155.

As each construction unit shown in FIG. 1 is independently shown to represent different characteristic functions in an image encoding device, it does not mean that each construction unit is constituted by separated hardware or one software unit. That is, as each construction unit is included by being enumerated as each construction unit for convenience of a description, at least two construction units of each construction unit may be combined to constitute one construction unit or one construction unit may be partitioned into a plurality of construction units to perform a function, and even an integrated embodiment and a separated embodiment of each construction unit are also included in a scope of a right of the present disclosure unless they are departing from the essence of the present disclosure.

Further, some components may be just an optional component for improving performance, not a necessary component which perform an essential function in the present disclosure. The present disclosure may be implemented by including only a construction unit necessary for implementing the essence of the present disclosure excluding a component used to just improve performance, and a structure including only a necessary component excluding an optional component used to just improve performance is also included in a scope of a right of the present disclosure.

A picture partitioning unit 110 may partition an input picture into at least one processing unit. In this case, a processing unit may be a prediction unit (PU), a transform unit (TU) or a coding unit (CU). In a picture partitioning unit 110, one picture may be partitioned into a combination of a plurality of coding units, prediction units and transform units and a picture may be encoded by selecting a combination of one coding unit, prediction unit and transform unit according to a predetermined standard (e.g., a cost function).

For example, one picture may be partitioned into a plurality of coding units. In order to partition a coding unit in a picture, a recursive tree structure such as a quad tree, a ternary tree, or a binary tree may be used, and a coding unit which is partitioned into other coding units by using one image or the largest coding unit as a route may be partitioned with as many child nodes as the number of partitioned coding units. A coding unit which is no longer partitioned according to a certain restriction becomes a leaf node. As an example, when it is assumed that quad tree partitioning is applied to one coding unit, one coding unit may be partitioned into up to four other coding units.

Hereinafter, in an embodiment of the present disclosure, a coding unit may be used as a unit for encoding or may be used as a unit for decoding.

A prediction unit may be partitioned with at least one square or rectangular shape, etc. in the same size in one coding unit or may be partitioned so that any one prediction unit of prediction units partitioned in one coding unit can have a shape and/or a size different from another prediction unit.

In intra prediction, a transform unit may be set to be the same as a prediction unit. In this case, after a coding unit is partitioned into a plurality of transform units, intra prediction may be performed per each transform unit. A coding unit may be partitioned in a horizontal direction or in a vertical direction. The number of transform units generated by partitioning a coding unit may be 2 or 4 according to a size of a coding unit.

Prediction units 120 and 125 may include an inter prediction unit 120 performing inter prediction and an intra prediction unit 125 performing intra prediction. Whether to perform inter prediction or intra prediction for a coding unit may be determined and detailed information according to each prediction method (e.g., an intra prediction mode, a motion vector, a reference picture, etc.) may be determined. In this case, a processing unit that prediction is performed may be different from a processing unit that a prediction method and details are determined. For example, a prediction method, a prediction mode, etc. may be determined in a coding unit and prediction may be performed in a prediction unit or in a transform unit. A residual value (a residual block) between a generated prediction block and an original block may be input to a transform unit 130. In addition, prediction mode information, motion vector information, etc. used for prediction may be encoded with a residual value in an entropy encoding unit 165 and may be transmitted to a decoding device. When a specific encoding mode is used, an original block may be encoded as it is and transmitted to a decoding unit without generating a prediction block through prediction units 120 or 125.

An inter prediction unit 120 may predict a prediction unit based on information on at least one picture of a previous picture or a subsequent picture of a current picture, or in some cases, may predict a prediction unit based on information on some encoded regions in a current picture. An inter prediction unit 120 may include a reference picture interpolation unit, a motion prediction unit and a motion compensation unit.

A reference picture interpolation unit may receive reference picture information from a memory 155 and generate pixel information equal to or less than an integer pixel in a reference picture. For a luma pixel, a 8-tap DCT-based interpolation filter having a different filter coefficient may be used to generate pixel information equal to or less than an integer pixel in a ¼ pixel unit. For a chroma signal, a 4-tap DCT-based interpolation filter having a different filter coefficient may be used to generate pixel information equal to or less than an integer pixel in a ⅛ pixel unit.

A motion prediction unit may perform motion prediction based on a reference picture interpolated by a reference picture interpolation unit. As a method for calculating a motion vector, various methods such as FBMA (Full search-based Block Matching Algorithm), TSS (Three Step Search), NTS (New Three-Step Search Algorithm), etc. may be used. A motion vector may have a motion vector value in a ½ or ¼ pixel unit based on an interpolated pixel. A motion prediction unit may predict a current prediction unit by varying a motion prediction method. As a motion prediction method, various methods such as a skip method, a merge method, an advanced motion vector prediction (AMVP) method, an intra block copy method, etc. may be used.

An intra prediction unit 125 may generate a prediction unit based on reference pixel information that is pixel information in a current picture. Reference pixel information may be derived from one selected among a plurality of reference pixel lines. A N-th reference pixel line among a plurality of reference pixel lines may include left pixels where an x-axis difference with a top-left pixel within a current block is N and top pixels where an y-axis difference with the top-left pixel is N. The number of reference pixel lines that may be selected by a current block may be 1, 2, 3, or 4.

When a neighboring block in a current prediction unit is a block which performed inter prediction and accordingly, a reference pixel is a pixel which performed inter prediction, a reference pixel included in a block which performed inter prediction may be used by being replaced with reference pixel information of a neighboring block which performed intra prediction. In other words, when a reference pixel is unavailable, unavailable reference pixel information may be used by being replaced with at least one information among the available reference pixels.

A prediction mode in intra prediction may have a directional prediction mode using reference pixel information according to a prediction direction and a non-directional mode not using directional information when performing prediction. A mode for predicting luma information may be different from a mode for predicting chroma information and intra prediction mode information used for predicting luma information or predicted luma signal information may be utilized to predict chroma information.

When a size of a prediction unit is the same as that of a transform unit in performing intra prediction, intra prediction for a prediction unit may be performed based on a pixel at a left position of a prediction unit, a pixel at a top-left position and a pixel at a top position.

An intra prediction method may generate a prediction block after applying a smoothing filter to a reference pixel according to a prediction mode. According to a selected reference pixel line, whether to apply a smoothing filter may be determined.

In order to perform an intra prediction method, an intra prediction mode in a current prediction unit may be predicted from an intra prediction mode in a prediction unit around a current prediction unit. When a prediction mode in a current prediction unit is predicted by using mode information predicted from a surrounding prediction unit, information that a prediction mode in a current prediction unit is the same as a prediction mode in a surrounding prediction unit may be transmitted by using predetermined flag information if an intra prediction mode in a current prediction unit is the same as an intra prediction mode in a surrounding prediction unit, and prediction mode information of a current block may be encoded by performing entropy encoding if a prediction mode in a current prediction unit is different from a prediction mode in a surrounding prediction unit.

In addition, a residual block may be generated which includes information on a residual value that is a difference value between a prediction unit which performed prediction based on a prediction unit generated in prediction units 120 and 125 and an original block in a prediction unit. A generated residual block may be input to a transform unit 130.

A transform unit 130 may transform an original block and a residual block including residual value information in a prediction unit generated through prediction units 120 and 125 by using a transform method such as DCT (Discrete Cosine Transform), DST (Discrete Sine Transform), KLT. Whether to apply DCT, DST or KLT to transform a residual block may be determined based on at least one of a size of a transform unit, a form of a transform unit, a prediction mode in a prediction unit or intra prediction mode information in a prediction unit.

A quantization unit 135 may quantize values transformed into a frequency domain in a transform unit 130. A quantization coefficient may be changed according to a block or importance of an image. A value calculated in a quantization unit 135 may be provided to a dequantization unit 140 and a rearrangement unit 160.

A rearrangement unit 160 may perform rearrangement of a coefficient value for a quantized residual value.

A rearrangement unit 160 may change a coefficient in a shape of a two-dimensional block into a shape of a one-dimensional vector through a coefficient scan method. For example, a rearrangement unit 160 may scan a DC coefficient to a coefficient in a high-frequency domain by using a zig-zag scan method and change it into a shape of a one-dimensional vector. According to a size of a transform unit and an intra prediction mode, instead of zig-zag scan, vertical scan where a coefficient in a shape of a two-dimensional block is scanned in a column direction, horizontal scan where a coefficient in a shape of a two-dimensional block is scanned in a row direction, or diagonal scan where a coefficient in a shape of a two-dimensional block is scanned in a diagonal direction may be used. In other words, which scan method among zig-zag scan, vertical directional scan, horizontal directional scan or diagonal scan will be used may be determined according to a size of a transform unit and an intra prediction mode.

An entropy encoding unit 165 may perform entropy encoding based on values calculated by a rearrangement unit 160. Entropy encoding, for example, may use various encoding methods such as exponential Golomb, CAVLC (Context-Adaptive Variable Length Coding), CABAC (Context-Adaptive Binary Arithmetic Coding).

An entropy encoding unit 165 may encode a variety of information such as residual value coefficient information and block type information in a coding unit, prediction mode information, partitioning unit information, prediction unit information and transmission unit information, motion vector information, reference frame information, block interpolation information, filtering information, etc. from a rearrangement unit 160 and prediction units 120 and 125.

An entropy encoding unit 165 may perform entropy encoding for a coefficient value in a coding unit which is input from a rearrangement unit 160.

A dequantization unit 140 and an inverse transform unit 145 dequantize values quantized in a quantization unit 135 and inversely transform values transformed in a transform unit 130. A residual value generated by a dequantization unit 140 and an inverse transform unit 145 may be combined with a prediction unit predicted by a motion prediction unit, a motion compensation unit and an intra prediction unit included in prediction units 120 and 125 to generate a reconstructed block.

A filter unit 150 may include at least one of a deblocking filter, an offset correction unit and an adaptive loop filter (ALF).

A deblocking filter may remove block distortion which is generated by a boundary between blocks in a reconstructed picture. In order to determine whether deblocking is performed, whether a deblocking filter will be applied to a current block may be determined based on a pixel included in several rows or columns included in a block. When a deblocking filter is applied to a block, a strong filter or a weak filter may be applied according to required deblocking filtering strength. In addition, in applying a deblocking filter, when horizontal filtering and vertical filtering are performed, horizontal directional filtering and vertical directional filtering may be set to be processed in parallel.

An offset correction unit may correct an offset with an original image in a unit of a pixel for an image that deblocking was performed. In order to perform offset correction for a specific picture, a region where an offset will be performed may be determined after dividing a pixel included in an image into the certain number of regions and a method in which an offset is applied to a corresponding region or a method in which an offset is applied by considering edge information of each pixel may be used.

Adaptive loop filtering (ALF) may be performed based on a value obtained by comparing a filtered reconstructed image with an original image. After a pixel included in an image is divided into predetermined groups, filtering may be discriminately performed per group by determining one filter which will be applied to a corresponding group. Information related to whether to apply ALF may be transmitted per coding unit (CU) for a luma signal and a shape and a filter coefficient of an ALF filter to be applied may vary according to each block. In addition, an ALF filter in the same shape (fixed shape) may be applied regardless of a characteristic of a block to be applied.

A memory 155 may store a reconstructed block or picture calculated through a filter unit 150 and a stored reconstructed block or picture may be provided to prediction units 120 and 125 when performing inter prediction.

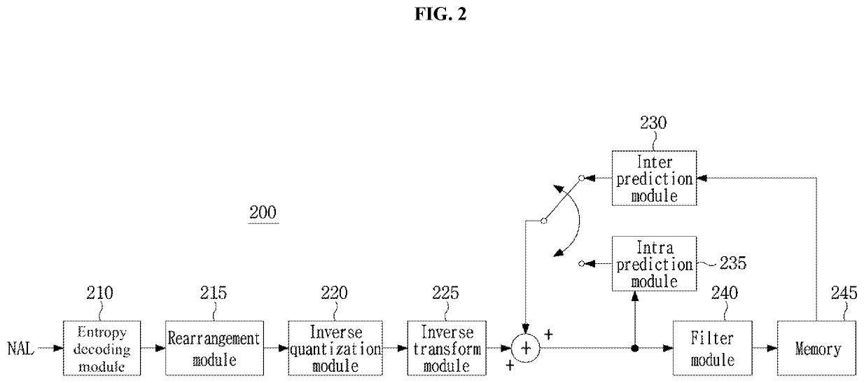

FIG. 2 is a block diagram showing an image decoding device according to an embodiment of the present disclosure.

Referring to FIG. 2, an image decoding device 200 may include an entropy decoding unit 210, a rearrangement unit 215, a dequantization unit 220, an inverse transform unit 225, prediction units 230 and 235, a filter unit 240, and a memory 245.

When an image bitstream is input from an image encoding device, an input bitstream may be decoded according to a procedure opposite to that of an image encoding device.

An entropy decoding unit 210 may perform entropy decoding according to a procedure opposite to a procedure in which entropy encoding is performed in an entropy encoding unit of an image encoding device. For example, in response to a method performed in an image encoding device, various methods such as Exponential Golomb, CAVLC (Context-Adaptive Variable Length Coding), CABAC (Context-Adaptive Binary Arithmetic Coding) may be applied.

An entropy decoding unit 210 may decode information related to intra prediction and inter prediction performed in an encoding device.

A rearrangement unit 215 may perform rearrangement based on a method that a bitstream entropy-decoded in an entropy decoding unit 210 is rearranged in an encoding unit. Coefficients expressed in a form of a one-dimensional vector may be rearranged by being reconstructed into coefficients in a form of a two-dimensional block. A rearrangement unit 215 may receive information related to coefficient scanning performed in an encoding unit and perform rearrangement through a method in which scanning is inversely performed based on scanning order performed in a corresponding encoding unit.

A dequantization unit 220 may perform dequantization based on a quantization parameter provided from an encoding device and a coefficient value of a rearranged block.

An inverse transform unit 225 may perform transform performed in a transform unit, i.e., inverse transform for DCT, DST, and KLT, i.e., inverse DCT, inverse DST and inverse KLT for a result of quantization performed in an image encoding device. Inverse transform may be performed based on a transmission unit determined in an image encoding device. In an inverse transform unit 225 of an image decoding device, a transform technique (for example, DCT, DST, KLT) may be selectively performed according to a plurality of information such as a prediction method, a size or a shape of a current block, a prediction mode, an intra prediction direction, etc.

Prediction units 230 and 235 may generate a prediction block based on information related to generation of a prediction block provided from an entropy decoding unit 210 and pre-decoded block or picture information provided from a memory 245.

As described above, when a size of a prediction unit is the same as a size of a transform unit in performing intra prediction in the same manner as an operation in an image encoding device, intra prediction for a prediction unit may be performed based on a pixel at a left position of a prediction unit, a pixel at a top-left position and a pixel at a top position, but when a size of a prediction unit is different from a size of a transform unit in performing intra prediction, intra prediction may be performed by using a reference pixel based on a transform unit. In addition, intra prediction using N×N partitioning may be used only for the smallest coding unit.

Prediction units 230 and 235 may include a prediction unit determination unit, an inter prediction unit and an intra prediction unit. A prediction unit determination unit may receive a variety of information such as prediction unit information, prediction mode information of an intra prediction method, motion prediction-related information of an inter prediction method, etc. which are input from an entropy decoding unit 210, divide a prediction unit in a current coding unit and determine whether a prediction unit performs inter prediction or intra prediction. An inter prediction unit 230 may perform inter prediction for a current prediction unit based on information included in at least one picture of a previous picture or a subsequent picture of a current picture including a current prediction unit by using information necessary for inter prediction in a current prediction unit provided from an image encoding device. Alternatively, inter prediction may be performed based on information on some regions which are pre-reconstructed in a current picture including a current prediction unit.

In order to perform inter prediction, whether a motion prediction method in a prediction unit included in a corresponding coding unit is a skip mode, a merge mode, an AMVP mode, or an intra block copy mode may be determined based on a coding unit.

An intra prediction unit 235 may generate a prediction block based on pixel information in a current picture. When a prediction unit is a prediction unit which performed intra prediction, intra prediction may be performed based on intra prediction mode information in a prediction unit provided from an image encoding device. An intra prediction unit 235 may include an adaptive intra smoothing (AIS) filter, a reference pixel interpolation unit and a DC filter. As a part performing filtering on a reference pixel of a current block, an AIS filter may be applied by determining whether a filter is applied according to a prediction mode in a current prediction unit. AIS filtering may be performed for a reference pixel of a current block by using AIS filter information and a prediction mode in a prediction unit provided from an image encoding device. When a prediction mode of a current block is a mode which does not perform AIS filtering, an AIS filter may not be applied.

When a prediction mode in a prediction unit is a prediction unit which performs intra prediction based on a pixel value which interpolated a reference pixel, a reference pixel interpolation unit may interpolate a reference pixel to generate a reference pixel in a unit of a pixel equal to or less than an integer value. When a prediction mode in a current prediction unit is a prediction mode which generates a prediction block without interpolating a reference pixel, a reference pixel may not be interpolated. A DC filter may generate a prediction block through filtering when a prediction mode of a current block is a DC mode.

A reconstructed block or picture may be provided to a filter unit 240. A filter unit 240 may include a deblocking filter, an offset correction unit and an ALF.

Information on whether a deblocking filter was applied to a corresponding block or picture and information on whether a strong filter or a weak filter was applied when a deblocking filter was applied may be provided from an image encoding device. Information related to a deblocking filter provided from an image encoding device may be provided in a deblocking filter of an image decoding device and deblocking filtering for a corresponding block may be performed in an image decoding device.

An offset correction unit may perform offset correction on a reconstructed image based on offset value information, a type of offset correction, etc. applied to an image when performing encoding.

An ALF may be applied to a coding unit based on information on whether ALF is applied, ALF coefficient information, etc. provided from an encoding device. Such ALF information may be provided by being included in a specific parameter set.

A memory 245 may store a reconstructed picture or block for use as a reference picture or a reference block and provide a reconstructed picture to an output unit.

As described above, hereinafter, in an embodiment of the present disclosure, a coding unit is used as a term of a coding unit for convenience of a description, but it may be a unit which performs decoding as well as encoding.

In addition, as a current block represents a block to be encoded/decoded, it may represent a coding tree block (or a coding tree unit), a coding block (or a coding unit), a transform block (or a transform unit), a prediction block (or a prediction unit), a block to which an in-loop filter is applied, etc. according to an encoding/decoding step. In this specification, ‘unit’ may represent a base unit for performing a specific encoding/decoding process and ‘block’ may represent a pixel array in a predetermined size. Unless otherwise classified, ‘block’ and ‘unit’ may be used interchangeably. For example, in the after-described embodiment, it may be understood that a coding block (a coding block) and a coding unit (a coding unit) are used interchangeably.

Furthermore, a picture in which a current block is included is called a current picture.

When encoding a current picture, redundant data between pictures may be removed through inter prediction. Inter prediction may be performed in a unit of a block. Specifically, the motion information of a current block may be used to generate a prediction block of a current block from a reference picture. Here, motion information may include at least one of a motion vector, a reference picture index, and a prediction direction.

The motion information of a current block may be generated through motion estimation.

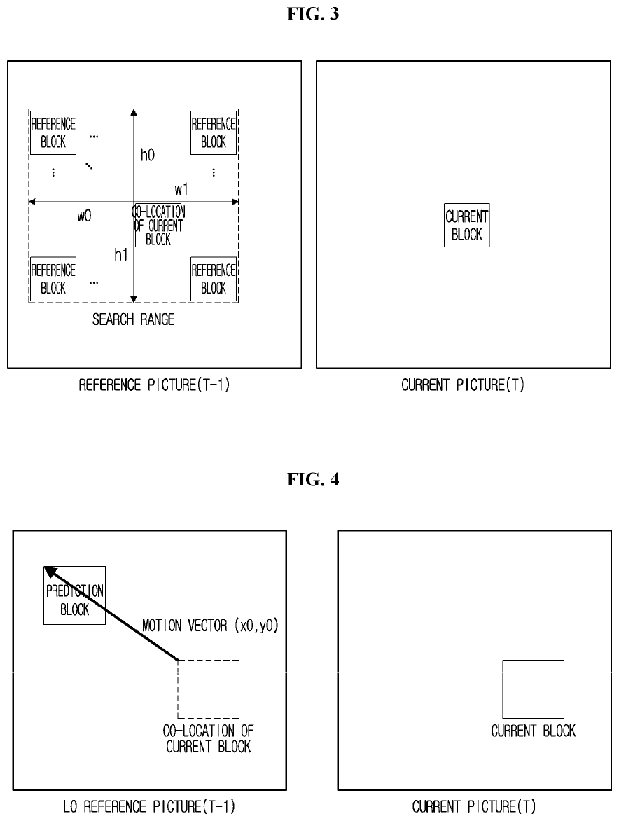

FIG. 3 shows an example in which motion estimation is performed.

In FIG. 3, it is assumed that the Picture Order Count (POC) of a current picture is T and the POC of a reference picture is (T−1).

A search range for motion estimation may be set from the same position as a reference point of a current block in a reference picture. Here, a reference point may be a position of a top-left sample of a current block.

As an example, in FIG. 3, it was illustrated that a square in a size of (w0+w01) and (h0+h1) is set to be within a search range centered on a reference point. In an example above, w0, w1, h0 and h1 may have the same value. Alternatively, at least one of w0, w1, h0 and h1 may be set to have a different value from the other. Alternatively, a size of w0, w1, h0 and h1 may be determined not to exceed a Coding Tree Unit (CTU) boundary, a slice boundary, a tile boundary or a picture boundary.

Within a search range, after reference blocks having the same size as a current block are set, a cost with a current block may be measured for each reference block. A cost may be calculated by using a similarity between two blocks.

As an example, a cost may be calculated based on the sum of absolute differences (SAD) between original samples in a current block and original samples (or reconstructed samples) in a reference block. As a SAD is smaller, a cost may be reduced.

Afterwards, a reference block with an optimal cost may be set as a prediction block of a current block by comparing a cost of each reference block.

Then, a distance between a current block and a reference block may be set as a motion vector. Specifically, a x-coordinate difference and a y-coordinate difference between a current block and a reference block may be set as a motion vector.

Furthermore, an index of a picture including a reference block specified through motion estimation is set as a reference picture index.

In addition, a prediction direction may be set based on whether a reference picture belongs to a L0 reference picture list or a L1 reference picture list.

In addition, motion estimation may be performed for each of a L0 direction and a L1 direction. When prediction is performed for both a L0 direction and a L1 direction, motion information in a L0 direction and motion information in a L1 direction may be generated, respectively.

FIGS. 4 and 5 show an example in which a prediction block of a current block is generated based on motion information generated through motion estimation.

FIG. 4 shows an example in which a prediction block is generated by unidirectional (i.e., L0 direction) prediction, and FIG. 5 shows an example in which a prediction block is generated by bidirectional (i.e., L0 and L1 direction) prediction.

For unidirectional prediction, a prediction block of a current block is generated by using one motion information. As an example, motion information may include a L0 motion vector, a L0 reference picture index and prediction direction information indicating a L0 direction.

For bidirectional prediction, a prediction block is generated by using two motion information. As an example, a reference block in a L0 direction specified based on motion information for a L0 direction (L0 motion information) may be set as a L0 prediction block, and a reference block in a L1 direction specified based on motion information for a L1 direction (L1 motion information) may be generated as a L1 prediction block. Afterwards, a L0 prediction block and a L1 prediction block may be weighted to generate a prediction block of a current block.

In an example shown in FIGS. 3 to 5, it was illustrated a L0 reference picture exists in a previous direction of a current picture (i.e., a POC value is smaller than that of a current picture) and a L1 reference picture exists in a subsequent direction of a current picture (i.e., a POC value is greater than that of a current picture).

However, unlike a shown example, a L0 reference picture may exist in a subsequent direction of a current picture, or a L1 reference picture may exist in a previous direction of a current picture. As an example, both a L0 reference picture and a L1 reference picture may exist in a previous direction of a current picture, or may exist in a subsequent direction of a current picture. Alternatively, bidirectional prediction may be performed by using a L0 reference picture existing in a subsequent direction of a current picture and a L1 reference picture existing in a previous direction of a current picture.

The motion information of a block where inter prediction is performed may be stored in a memory. In this case, motion information may be stored in a unit of a sample. Specifically, the motion information of a block to which a specific sample belongs may be stored as the motion information of a specific sample. Stored motion information may be used to derive the motion information of a neighboring block to be decoded/decoded later.

In an encoder, information obtained by encoding a residual sample corresponding to a difference value between a sample of a current block (i.e., an original sample) and a prediction sample and motion information necessary for generating a prediction block may be signaled to a decoder. In a decoder, information about a signaled difference value may be decoded to derive a difference sample, and a reconstructed sample may be generated by adding a prediction sample in a prediction block generated by using motion information to the difference sample.

In this case, in order to effectively compress motion information signaled to a decoder, one of a plurality of inter prediction modes may be selected. Here, a plurality of inter prediction modes may include a motion information merge mode and a motion vector prediction mode.

A motion vector prediction mode is a mode that encodes and signals a difference value between a motion vector and a motion vector prediction value. Here, a motion vector prediction value may be derived based on motion information of a neighboring sample or a neighboring block adjacent to a current block.

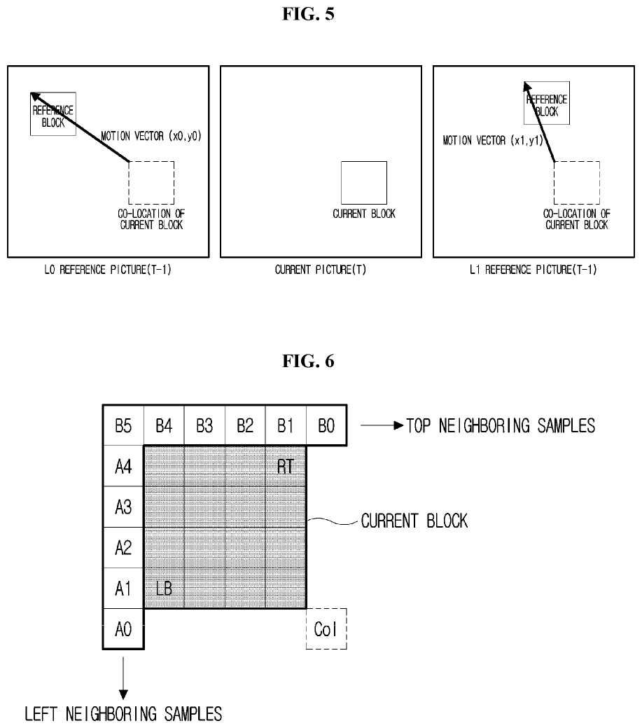

FIG. 6 shows a position referred to for deriving a motion vector prediction value.

For convenience of a description, it is assumed that a current block has a size of 4×4.

In a shown example, ‘LB’ represents a sample included in the leftmost column and the bottommost row in a current block. ‘RT’ represents a sample included in the rightmost column and the topmost row in a current block. A0 to A4 represent samples neighboring the left of a current block, and B0 to B5 represent samples neighboring the top of a current block. As an example, A1 represents a sample neighboring the left of LB, and B1 represents a sample neighboring the top of RT.

Col represents a position of a sample neighboring the bottom-right of a current block in a co-located picture. A col-located picture is a picture different from a current picture, and information for specifying a col-located picture may be explicitly encoded and signaled in a bitstream. Alternatively, a reference picture having a predefined reference picture index may be set as a col-located picture.

A motion vector prediction value of a current block may be derived from at least one motion vector prediction candidate included in a motion vector prediction list.

The number of motion vector prediction candidates that may be inserted into a motion vector prediction list (i.e., a size of a list) may be predefined in an encoder and a decoder. As an example, the maximum number of motion vector prediction candidates may be 2.

A motion vector stored in a position of a neighboring sample adjacent to a current block or a scaled motion vector derived by scaling the motion vector may be inserted into a motion vector prediction list as a motion vector prediction candidate. In this case, neighboring samples adjacent to a current block may be scanned in predefined order to derive a motion vector prediction candidate.

As an example, whether a motion vector is stored at each position in the order of A0 to A4 may be confirmed. And, according to the scan order, an available motion vector found first may be inserted into a motion vector prediction list as a motion vector prediction candidate.

As another example, whether a motion vector is stored at each position in the order of A0 to A4 is confirmed, and a motion vector at a position with the same reference picture as a current block that is found first may be inserted into a motion vector prediction list as a motion vector prediction candidate. If there is no neighboring sample that has the same reference picture as a current block, a motion vector prediction candidate may be derived based on an available vector found first. Specifically, after scaling an available motion vector found first, a scaled motion vector may be inserted into a motion vector prediction list as a motion vector prediction candidate. In this case, scaling may be performed based on an output order difference between a current picture and a reference picture (i.e., a POC difference) and an output order difference between a current picture and a reference picture of a neighboring sample (i.e., a POC difference).

Furthermore, in the order of B0 to B5, whether a motion vector is stored at each position may be confirmed. And, according to the scan order, an available motion vector found first may be inserted into a motion vector prediction list as a motion vector prediction candidate.

As another example, whether a motion vector is stored at each position in the order of B0 to B5 is confirmed, and a motion vector at a position with the same reference picture as a current block that is found first may be inserted into a motion vector prediction list as a motion vector prediction candidate. If there is no neighboring sample that has the same reference picture as a current block, a motion vector prediction candidate may be derived based on an available vector found first. Specifically, after scaling an available motion vector found first, a scaled motion vector may be inserted into a motion vector prediction list as a motion vector prediction candidate. In this case, scaling may be performed based on an output order difference between a current picture and a reference picture (i.e., a POC difference) and an output order difference between a current picture and a reference picture of a neighboring sample (i.e., a POC difference).

As in an example described above, a motion vector prediction candidate may be derived from a sample adjacent to the left of a current block, and a motion vector prediction candidate may be derived from a sample adjacent to the top of a current block.

In this case, a motion vector prediction candidate derived from a left sample may be inserted into a motion vector prediction list before a motion vector prediction candidate derived from a top sample. In this case, an index allocated to a motion vector prediction candidate derived from a left sample may have a smaller value than a motion vector prediction candidate derived from a top sample.

Conversely, a motion vector prediction candidate derived from a top sample may be inserted into a motion vector prediction list before a motion vector prediction candidate derived from a left sample.

Among the motion vector prediction candidates included in the motion vector prediction list, a motion vector prediction candidate with the highest encoding efficiency may be set as a motion vector predictor (MVP) of a current block. And, index information indicating a motion vector prediction candidate set as a motion vector prediction value of a current block among a plurality of motion vector prediction candidates may be encoded and signaled to a decoder. When the number of motion vector prediction candidates is 2, the index information may be a 1-bit flag (e.g., a MVP flag). In addition, a motion vector difference (MVD), which is a difference between a motion vector of a current block and a motion vector predictor, may be encoded and signaled to a decoder.

A decoder may configure a motion vector prediction list in the same manner as an encoder. In addition, index information may be decoded from a bitstream, and one of a plurality of motion vector prediction candidates may be selected based on decoded index information. A selected motion vector prediction candidate may be set as a motion vector prediction value of a current block.

In addition, a motion vector difference value may be decoded from a bitstream. Afterwards, a motion vector of a current block may be derived by combining a motion vector prediction value and a motion vector difference value.

When bidirectional prediction is applied to a current block, a motion vector prediction list may be generated for each of a L0 direction and a L1 direction. In other words a motion vector prediction list may be composed of motion vectors in the same direction. Accordingly, a motion vector of a current block and motion vector prediction candidates included in a motion vector prediction list have the same direction.

When a motion vector prediction mode is selected, a reference picture index and prediction direction information may be explicitly encoded and signaled to a decoder. As an example, when there are a plurality of reference pictures on a reference picture list and motion estimation is performed for each of a plurality of reference pictures, a reference picture index for specifying a reference picture where motion information of a current block is derived among the plurality of reference pictures may be explicitly encoded and signaled to a decoder.

In this case, when only one reference picture is included in a reference picture list, the encoding/decoding of the reference picture index may be omitted.

Prediction direction information may be an index indicating one of L0 unidirectional prediction, L1 unidirectional prediction, or bidirectional prediction. Alternatively, a L0 flag representing whether prediction for a L0 direction is performed and a L1 flag representing whether prediction for a L1 direction is performed may be encoded and signaled, respectively.

A motion information merge mode is a mode that sets the motion information of a current block to be the same as the motion information of a neighboring block. In a motion information merge mode, motion information may be decoded/encoded by using a motion information merge list.

A motion information merge candidate may be derived based on the motion information of a neighboring block or a neighboring sample adjacent to a current block. As an example, after pre-defining a reference position around a current block, whether motion information exists at a pre-defined reference position may be confirmed. When motion information exists at a pre-defined reference position, motion information at a corresponding position may be inserted into a motion information merge list as a motion information merge candidate.

In an example of FIG. 6, a pre-defined reference position may include at least one of A0, A1, B0, B1, B5 and Col. Furthermore, a motion information merge candidate may be derived in the order of A1, B1, B0, A0, B5 and Col.

Among the motion information merge candidates included in a motion information merge list, the motion information of a motion information merge candidate having an optimal cost may be set as the motion information of a current block. Furthermore, index information (e.g., a merge index) indicating a motion information merge candidate selected among a plurality of motion information merge candidates may be encoded and transmitted to a decoder.

In a decoder, a motion information merge list may be configured in the same way as in an encoder. And, a motion information merge candidate may be selected based on a merge index decoded from a bitstream. The motion information of a selected motion information merge candidate may be set as the motion information of a current block.

Unlike a motion vector prediction list, a motion information merge list is configured as a single list regardless of a prediction direction. In other words, a motion information merge candidate included in a motion information merge list may have only L0 motion information or L1 motion information, or may have bidirectional motion information (i.e., L0 motion information and L1 motion information).

A reconstructed sample region around a current block may be used to derive the motion information of a current block. Here, a reconstructed sample region used to derive the motion information of a current block may also be called a template.

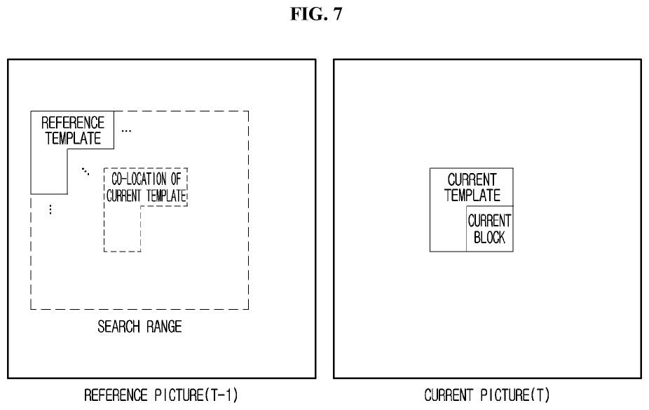

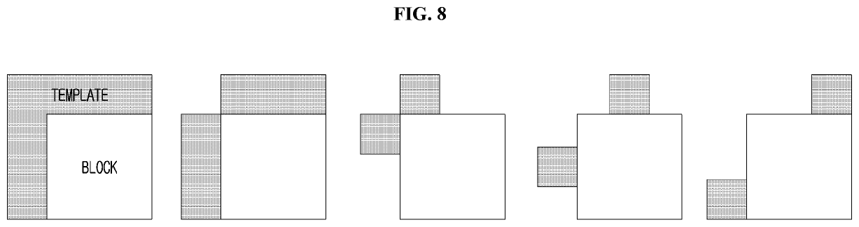

FIG. 7 is a diagram for describing a template-based motion estimation method.

In FIG. 3, it was described that a prediction block of a current block is determined based on a cost between a current block and a reference block within a search range. According to this embodiment, unlike FIG. 3, motion estimation for a current block may be performed based on a cost between a template neighboring a current block (hereinafter, referred to as a current template) and a reference template having the same size and shape as a current template.

As an example, a cost may be calculated based on a SAD of a difference value between reconstructed samples in a current template and reconstructed samples in a reference block. As a SAD is smaller, a cost may be reduced.

When a current template in a search range and a reference template having an optimal cost are determined, a reference block neighboring a reference template may be set as a prediction block of a current block.

And, the motion information of a current block may be set based on a distance between a current block and a reference block, an index of a picture to which a reference block belongs, and whether a reference picture is included in a L0 or L1 reference picture list.

Since a pre-reconstructed region around a current block is defined as a template, a decoder itself may perform motion estimation in the same manner as an encoder. Accordingly, when motion information is derived by using a template, there is no need to encode and signal motion information other than information representing whether to use a template.

A current template may include at least one of a region adjacent to the top of a current block or a region adjacent to the left of a current block. In this case, a region adjacent to the top may include at least one row, and a region adjacent to the left may include at least one column.

FIG. 8 shows examples in which a template is configured.

A current template may be configured according to one of the examples shown in FIG. 8.

Alternatively, unlike an example shown in FIG. 8, a template may be configured only with regions adjacent to the left of a current block, or a template may be configured only with regions adjacent to the top of a current block.

A size and/or a shape of a current template may be predefined in an encoder and a decoder.

Alternatively, after pre-defining a plurality of template candidates having a different size and/or shape, index information specifying one of a plurality of template candidates may be encoded and signaled to a decoder.

Alternatively, one of a plurality of template candidates may be adaptively selected based on at least one of a size, a shape or a position of a current block. As an example, when a current block adjoins a top boundary of a CTU, a current template may be configured only with regions adjacent to the left of a current block.

Template-based motion estimation may be performed on each reference picture stored in a reference picture list. Alternatively, motion estimation may be performed on only some of the reference pictures. As an example, motion estimation may be performed only for a reference picture whose reference picture index is 0, or motion estimation may be performed only for reference pictures whose reference picture index is less than a threshold value or reference pictures whose POC difference with a current picture is less than a threshold value.

Alternatively, motion estimation may be performed only for a reference picture indicated by the reference picture index after explicitly encoding and signaling a reference picture index.

Alternatively, motion estimation may be performed for a reference picture of a neighboring block corresponding to a current template. As an example, if a template is composed of a left adjacent region and a top adjacent region, at least one reference picture may be selected by using at least one of a reference picture index of a left neighboring block or a reference picture index of a top neighboring block. Afterwards, motion estimation may be performed for at least one selected reference picture.

Information representing whether template-based motion estimation is applied may be encoded and signaled to a decoder. The information may be a 1-bit flag. As an example, when the flag is true (1), it indicates that template-based motion estimation is applied to a L0 direction and a L1 direction of a current block. On the other hand, when the flag is false (0), it indicates that template-based motion estimation is not applied. In this case, motion information of a current block may be derived based on a motion information merge mode or a motion vector prediction mode. Conversely, only when it is determined that a motion information merge mode and a motion vector prediction mode are not applied to a current block, template-based motion estimation may be applied. As an example, when both a first flag representing whether a motion information merge mode is applied and a second flag representing whether a motion vector prediction mode is applied are 0, template-based motion estimation may be performed.

Information representing whether template-based motion estimation is applied may be signaled for each of a L0 direction and a L1 direction. In other words, whether template-based motion estimation is applied to a L0 direction and whether template-based motion estimation is applied to a L1 direction may be determined independently. Accordingly, template-based motion estimation may be applied to any one of a L0 direction and a L1 direction, while a different mode (e.g., a motion information merge mode or a motion vector prediction mode) may be applied to the other.

When template-based motion estimation is applied to both a L0 direction and a L1 direction, a prediction block of a current block may be generated based on the weighted sum operation of a L0 prediction block and a L1 prediction block. Alternatively, even when template-based motion estimation is applied to one of a L0 direction and a L1 direction, but a different mode is applied to the other, a prediction block of a current block may be generated based on the weighted sum operation of a L0 prediction block and a L1 prediction block.

Alternatively, a template-based motion estimation method may be inserted as a motion information merge candidate on a motion information merge mode or a motion vector prediction candidate on a motion vector prediction mode. In this case, whether to apply a template-based motion estimation method may be determined based on whether a selected motion information merge candidate or a selected motion vector prediction candidate indicates a template-based motion estimation method.

Based on a bilateral matching method, the motion information of a current block may also be generated.

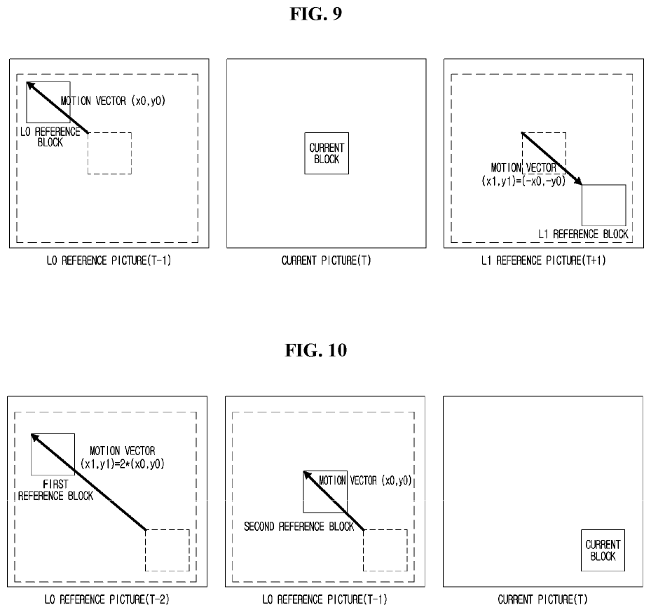

FIG. 9 is a diagram for describing a motion estimation method based on a bilateral matching method.

A bilateral matching method may be performed only when the temporal order (i.e., POC) of a current picture exists between the temporal order of a L0 reference picture and the temporal order of a L1 reference picture.

When a bilateral matching method is applied, a search range may be set for each of a L0 reference picture and a L1 reference picture. In this case, a L0 reference picture index for identifying a L0 reference picture and a L1 reference picture index for identifying a L1 reference picture may be encoded and signaled, respectively.

As another example, only a L0 reference picture index may be encoded and signaled, and a L1 reference picture may be selected based on a distance between a current picture and a L0 reference picture (hereinafter, referred to as a L0 POC difference). As an example, among the L1 reference pictures included in a L1 reference picture list, a L1 reference picture that an absolute value of a distance with a current picture (hereinafter, referred to as a L1 POC difference) is the same as an absolute value of a distance between a current picture and a L0 reference picture may be selected. When there is no L1 reference picture having the same L1 POC difference as a L0 POC difference, a L1 reference picture that a L1 POC difference is most similar to a L0 POC difference may be selected among the L1 reference pictures.

In this case, only a L1 reference picture whose temporal direction is different from that of a L0 reference picture among the L1 reference pictures may be used for bilateral matching. As an example, when a POC of a L0 reference picture is smaller than that of a current picture, one of the L1 reference pictures whose POC is larger than that of a current picture may be selected.

Conversely, only a L1 reference picture index may be encoded and signaled, and a L0 reference picture may be selected based on a distance between a current picture and a L1 reference picture.

Alternatively, a bilateral matching method may be performed by using a L0 reference picture closest to a current picture among the L0 reference pictures and a L1 reference picture closest to a current picture among the L1 reference pictures.

Alternatively, a bilateral matching method may be performed by using a L0 reference picture (e.g., index 0) to which a predefined index in a L0 reference picture list is allocated and a L1 reference picture (e.g., index 0) to which a predefined index in a L1 reference picture list is allocated.

Alternatively, a LX (X is 0 or 1) reference picture may be selected based on an explicitly signaled reference picture index, and a L|X−1| reference picture may be selected as a reference picture closest to a current picture among the L|X−1| reference pictures or a reference picture having a predefined index in a L|X−1| reference picture list.

As another example, L0 and/or L1 reference pictures may be selected based on the motion information of a neighboring block of a current block. As an example, L0 and/or L1 reference pictures to be used for bilateral matching may be selected by using a reference picture index of a left or top neighboring block of a current block.

A search range may be set within a predetermined range from a col-located block in a reference picture.

As another example, a search range may be set based on initial motion information. Initial motion information may be derived from a neighboring block of a current block. As an example, the motion information of a left neighboring block or a top neighboring block of a current block may be set as the initial motion information of a current block.

When a bilateral matching method is applied, a L0 motion vector and a motion vector in a L1 direction are set in an opposite direction. It represents that a sign of a L0 motion vector is opposite to a sign of a motion vector in a L1 direction. In addition, a size of a LX motion vector may be proportional to a distance between a current picture and a LX reference picture (i.e., a POC difference).

Afterwards, motion estimation may be performed by using a cost between a reference block belonging to a search range of a L0 reference picture (hereinafter, referred to as a L0 reference block) and a reference block belonging to a search range of a L1 reference picture (hereinafter, referred to as a L1 reference block).

When a L0 reference block that a vector with a current block is (x, y) is selected, a L1 reference block at a position spaced by (−Dx, −Dy) from a current block may be selected. Here, D may be determined by a ratio of a distance between a current picture and a L0 reference picture and a distance between a L1 reference picture and a current picture.

As an example, in an example shown in FIG. 9, an absolute value of a distance between a current picture (T) and a L0 reference picture (T−1) is mutually the same as an absolute value of a distance between a current picture (T) and a L1 reference picture (T+1). Accordingly, in a shown example, a L0 motion vector (x0, y0) and a L1 motion vector (x1, y1) have the same size, but an opposite distance. If a L1 reference picture that a POC is (T+2) is used, a L1 motion vector (x1, y1) will be set as (−2*x0, −2*y0).

When a L0 reference block and a L1 reference block having an optimal cost are selected, each of a L0 reference block and a L1 reference block may be set as a L0 prediction block and a L1 prediction block of a current block. Afterwards, a final prediction block of a current block may be generated through a weighted sum operation of a L0 reference block and a L1 reference block.

When a bilateral matching method is applied, a decoder may perform motion estimation in the same manner as an encoder. Accordingly, information representing whether a bilateral motion matching method is applied may be explicitly encoded/decoded, while decoding/encoding of motion information such as a motion vector, etc. may be omitted. As described above, at least one of a L0 reference picture index or a L1 reference picture index may be explicitly encoded/decoded.

As another example, when information representing whether a bilateral matching method is applied is explicitly encoded/decoded, but a bilateral matching method is applied, a L0 motion vector or a L1 motion vector may be explicitly encoded and signaled. When a L0 motion vector is signaled, a L1 motion vector may be derived based on a POC difference between a current picture and a L0 reference picture and a POC difference between a current picture and a L1 reference picture. When a L1 motion vector is signaled, a L0 motion vector may be derived based on a POC difference between a current picture and a L0 reference picture and a POC difference between a current picture and a L1 reference picture. In this case, an encoder may explicitly encode the smaller one between a L0 motion vector and a L1 motion vector.

Information representing whether a bilateral matching method is applied may be a 1-bit flag. As an example, when the flag is true (e.g., 1), it may represent that a bilateral matching method is applied to a current block. When the flag is false (e.g., 0), it may represent that a bilateral matching method is not applied to a current block. In this case, a motion information merge mode or a motion vector prediction mode may be applied to a current block.

Conversely, a bilateral matching method may be applied only when it is determined that a motion information merge mode and a motion vector prediction mode are not applied to a current block. As an example, when both a first flag representing whether a motion information merge mode is applied and a second flag representing whether a motion vector prediction mode is applied are 0, a bilateral matching method may be applied.

Alternatively, a bilateral matching method may be inserted as a motion information merge candidate on a motion information merge mode or a motion vector prediction candidate on a motion vector prediction mode. In this case, whether to apply a bilateral matching method may be determined based on whether a selected motion information merge candidate or a selected motion vector prediction candidate indicates a bilateral matching method.

In a bilateral matching method, it was illustrated that the temporal order of a current picture must exist between the temporal order of a L0 reference picture and the temporal order of a L1 reference picture. A unidirectional matching method to which a constraint of the bilateral matching method is not applied may be applied to generate a prediction block of a current block. Specifically, in a unidirectional matching method, two reference pictures having temporal order smaller than that of a current block (i.e., a POC) or two reference pictures having temporal order larger than that of a current block may be used. In this case, two reference pictures may be derived from a L0 reference picture list or a L1 reference picture list. Alternatively, one of the two reference pictures may be derived from a L0 reference picture list and the other may be derived from a L1 reference picture list.

FIG. 10 is a diagram for describing a motion estimation method based on a unilateral matching method.

A unilateral matching method may be performed based on two reference pictures having a POC smaller than that of a current picture (i.e., forward reference pictures) or two reference pictures having a POC larger than that of a current picture (i.e., backward reference pictures). In FIG. 10, it was illustrated that motion estimation based on a unilateral matching method is performed based on a first reference picture (T−1) and a second reference picture (T−2) having a POC smaller than that of a current picture (T).

In this case, a first reference picture index for identifying a first reference picture and a second reference picture index for identifying a second reference picture may be encoded and signaled, respectively. In this case, among two reference pictures used for a unilateral matching method, a reference picture having a smaller POC difference from a current picture may be set as a first reference picture. Accordingly, when a first reference picture is selected, only reference pictures having a larger POC difference from a current picture than a first reference picture among the reference pictures included in a reference picture list may be set as a second reference picture. A second reference picture index may be set to indicate an index of one of the reordered reference pictures after reordering reference pictures having the same temporal direction as a first reference picture and having a larger POC difference from a current picture than a first reference picture.

Conversely, a reference picture having a larger POC difference from a current picture among the two reference pictures may be set as a first reference picture. In this case, a second reference picture index may be set to indicate an index of one of the reordered reference pictures after reordering reference pictures having the same temporal direction as a first reference picture and having a smaller POC difference from a current picture than a first reference picture.

Alternatively, a unilateral matching method may be performed by using a reference picture to which a predefined index in a reference picture list is allocated and a reference picture having the same temporal direction. As an example, a reference picture having an index of 0 in a reference picture list may be set as a first reference picture, and a reference picture having the smallest index among the reference pictures having the same temporal direction as a first reference picture in a reference picture list may be selected as a second reference picture.

Both a first reference picture and a second reference picture may be selected from a L0 reference picture list or a L1 reference picture list. In FIG. 10, it was shown that two L0 reference pictures are used for a unilateral matching method. Alternatively, a first reference picture may be selected from a L0 reference picture list, and a second reference picture may be selected from a L1 reference picture list.

Information representing whether a first reference picture and/or a second reference picture belongs to a L0 reference picture list or a L1 reference picture list may be additionally encoded/decoded.

Alternatively, unilateral matching may be performed by using one of a L0 reference picture list and a L1 reference picture list set as default. Alternatively, two reference pictures may be selected from a L0 reference picture list and a L1 reference picture list, whichever has a larger number of reference pictures.

Afterwards, a search range within a first reference picture and a second reference picture may be set.

A search range may be set within a predetermined range from a collocated block in a reference picture.

As another example, a search range may be set based on initial motion information. Initial motion information may be derived from the neighboring block of a current block. As an example, the motion information of a left neighboring block or a top neighboring block of a current block may be set as the initial motion information of a current block.

Afterwards, motion estimation may be performed by using a cost between a first reference block belonging to the search range of a first reference picture and a second reference block belonging to the search range of a second reference picture.

In this case, under a unilateral matching method, the size of a motion vector must be set to increase in proportion to a distance between a current picture and a reference picture. Specifically, when a first reference block whose vector with a current picture is (x, y) is selected, a second reference block must be separated from a current block by (Dx, Dy). Here, D may be determined by the ratio of a distance between a current picture and a first reference picture and a distance between a current picture and a second reference picture.

As an example, in an example of FIG. 10, a distance between a current picture and a first reference picture (i.e., a POC difference) is 1, and a distance between a current picture and a second reference picture (i.e., a POC difference) is 2. Accordingly, when a first motion vector for a first reference block in a first reference picture is (x0, y0), a second motion vector (x1, y1) for a second reference block in a second reference picture may be set as (2x0, 2y0).

When a first reference block and a second reference block having an optimal cost are selected, a first reference block and a second reference block may be set as a first prediction block and a second prediction block of a current block, respectively. Afterwards, the final prediction block of a current block may be generated through the weighted sum operation of a first prediction block and a second prediction block.

When a unilateral matching method is applied, a decoder may perform motion estimation in the same manner as an encoder. Accordingly, information representing whether a unilateral motion matching method is applied is explicitly encoded/decoded, while encoding/decoding of motion information such as a motion vector, etc. may be omitted. As described above, at least one of a first reference picture index or a second reference picture index may be explicitly encoded/decoded.

As another example, information representing whether a unilateral matching method is applied is explicitly encoded/decoded, and when a unilateral matching method is applied, a first motion vector or a second motion vector may be explicitly encoded and signaled. When a first motion vector is signaled, a second motion vector may be derived based on a POC difference between a current picture and a first reference picture and a POC difference between a current picture and a second reference picture. When a second motion vector is signaled, a first motion vector may be derived based on a POC difference between a current picture and a first reference picture and a POC difference between a current picture and a second reference picture. In this case, an encoder may explicitly encode the smaller one of a first motion vector and a second motion vector.

Information representing whether a unilateral matching method is applied may be a 1-bit flag. As an example, when the flag is true (e.g., 1), it may represent that a unilateral matching method is applied to a current block. When the flag is false (e.g., 0), it may represent that a unilateral matching method is not applied to a current block. In this case, a motion information merging mode or a motion vector prediction mode may be applied to a current block. Conversely, a unilateral matching method may be applied only when it is determined that a motion information merging mode and a motion vector prediction mode are not applied to a current block. As an example, when both a first flag representing whether a motion information merging mode is applied and a second flag representing whether a motion vector prediction mode is applied are 0, a unilateral matching method may be applied.

Alternatively, a unilateral matching method may be inserted as a motion information merge candidate in a motion information merge mode or a motion vector prediction candidate in a motion vector prediction mode. In this case, whether to apply a unilateral matching method may be determined based on whether a selected motion information merge candidate or a selected motion vector prediction candidate indicates a unilateral matching method.

In generating a bitstream, an encoder may perform binarization based on Context-based Arithmetic Binary Coding (CABAC). In this case, encoding/decoding of a bitstream may be performed in a unit of a bin. Specifically, a encoder performs encoding in a unit of a bin to output a bit, and a decoder receives a bit to output a bin through CABAC.

Meanwhile, a set of bins may be named a bin string. As an example, when the value of a syntax merge_idx is 4, the value of the syntax merge_idx may be binarized to 1110. In this case, each of 1 and 0 represents a bin and 1110 represents a bin string. In other words, a syntax merge_idx with a value of 4 may be represented as a bin string composed of 4 bins.

Each bin constructing a bin string may be identified by a bin index. Specifically, an index may be sequentially allocated in order from the left to the right of a bin string. As an example, when a bin string is 1110, the value of a bin to which index 0 is allocated may be 1, the value of a bin to which index 1 is allocated may be 1, the value of a bin to which index 2 is allocated may be 1 and the value of a bin to which index 3 is allocated may be 0.

Meanwhile, encoding/decoding for a bin may be performed based on a general coding engine or through a bypass coding engine.

FIG. 11 shows an example in which decoding is performed in a unit of a bin.

As in a shown example, according to the value of a variable bypassFlag, whether decoding of a bin is performed through a general coding engine or a bypass coding engine may be determined. Here, a general coding engine may represent a coding method using context information and a bypass coding engine may represent a coding method not using context information.

A variable bypassFlag is an internal variable defined in an encoder and a decoder, which represents whether a bin to be encoded/decoded is encoded through a bypass coding engine.

Meanwhile, whether to use a bypass coding engine may be determined for each syntax element or each bin of a syntax element. As an example, in encoding/decoding a residual coefficient, the value of a variable bypassFlag may be determined based on whether the number of bins encoded through probability encoding reaches a threshold value (e.g., Context Coded Bin (CCB)). Alternatively, according to the type of a syntax element, the value of a variable bypassFlag may be determined.

According to a variable bypassFlag, a bin may be encoded/decoded based on a general coding engine or a bypass coding engine. Hereinafter, a method for encoding/decoding a bin will be described in detail.

In order to encode/decode a bin by using CABAC, initialization of a probability and a coding engine may be performed.

An initial probability may be determined according to a slice type and/or a bin index. Accordingly, an initial probability value (initValue) may be different for each bin index. An initial probability value may be expressed as 6 bits.

When an initial probability value (initValue) is determined, two probability state indexes may be derived by using an initial probability value. Equations 1 to 7 represent a process of deriving a first probability state index pStateIdx0 and a second probability state index pStateIdx1 by using an initial probability value initValue.

$$slopeIdx = initValue ≫ 3 \qquad [ Equation 1 ]$$

$$offsetIdx = initValue \& 7 \qquad [ Equation 2 ]$$

$$m = slopeIdx - 4 \qquad [ Equation 3 ]$$

$$n = ( offsetIdx * 18 ) + 1 \qquad [ Equation 4 ]$$

$$preCtxState = Clip 3 ( 1 , 127 , ( ( m * ( C lip 3 ( 0 , 51 , SliceQpY ) - 16 ) ) ≫ 1 ) + n ) \qquad [ Equation 5 ]$$

$$pStateIdx 0 = preCtxState ≪ 3 \qquad [ Equation 6 ]$$

$$pStateIdx 1 = preCtxState ≪ 7 \qquad [ Equation 7 ]$$

Two probability state indexes are a value representing a probability that the value of a bin is 1 (i.e., an occurrence probability of 1) as an index. In other words, as the value of a probability state index is larger, a probability that the value of a bin is 1 may increase.

A first probability state index and a second probability state index have a difference in speed at which a probability is updated. As an example, when a bin with a value of 1 is continuously input, a first probability state index pStateIdx0 is updated to increase rapidly compared to a second probability state index pStateIdx1. In other words, a second probability state index pStateIdx1 is updated to increase relatively slowly compared to a first probability state index pStateIdx0.

Finally, an occurrence probability of 1 is determined by averaging a first probability state index pStateIdx0 and a second probability state index pStateIdx1. Meanwhile, referring to Equations 6 and 7, there is a 4-bit length difference between a first probability state index pStateIdx0 and a second probability state index pStateIdx1. Accordingly, when calculating an average between a first probability state index pStateIdx0 and a second probability state index pStateIdx1, the precision of two variables may be adjusted equally. As an example, after performing an operation to shift a first probability state index pStateIdx0 to the left by 4, an average between a shifted first probability state index and a second probability state index pStateIdx1 may be obtained.

A coding engine may operate based on a variable ivlCurrRange and a variable ivlOffset. In this case, a variable ivlCurrRange may be initialized to a predefined value (e.g., 510). On the other hand, a variable ivlOffset may be initialized based on information parsed from a bitstream (e.g., 9-bit information).

FIG. 12 represents a decoding method based on a general coding engine.

In order to decode one bin, a probability may be set. To this end, a variable pSate representing a probability state may be derived. A variable pState may be derived by averaging a first probability state index pStateIdx0 and a second probability state index pStateIdx1. In addition, in order to adjust the precision of two probability state indexes equally, a first probability state index pStateIdx0 may be shifted to the left by 4 to derive a variable pState. Meanwhile, a variable pState may be a positive integer expressed as 15 bits.

A value with a higher occurrence probability of 0 and 1 may be set as a Most Probable Symbol (MPS) and a value with a lower occurrence probability may be set as a Least Probable Symbol (LPS). Since the value of a bin is one of 0 and 1, the sum of an occurrence probability of 0 and an occurrence probability of 1 may be 1.0.

According to a variable pState, whether the value of a MPS is 0 or 1 may be determined. A variable valMps representing whether a MPS is 0 or 1 may be derived by Equation 8 below.

$$valMps = pState ≫ 14 \qquad [ Equation 8 ]$$

A variable pState is a positive integer expressed as 15 bits. Accordingly, when the value of a variable pState is greater than 16383, valMps may be set as 1. It means that an occurrence probability of 1 is higher than that of 0.

On the other hand, when the value of a variable pState is equal to or less than 16383, a variable valMps may be set as 0. It means that an occurrence probability of 0 is higher than that of 1.

A variable ivlLpsRange represents the range of a LPS. A variable ivlLpsRange may be derived by Equations 9 and 10 below.

$$qRangeIdx = ivlCurrRange ≫ 5 \qquad [ Equation 9 ]$$

$$ivlLpsRange = ( qRangeIdx * ( ( valMps ? 32767 - pState : pState ) ≫ 9 ) ≫ 1 ) + 4 \qquad [ Equation 10 ]$$

The range of a MPS ivlMpsRange may be derived by subtracting a variable ivlLpsRange from a variable ivlCurrRange.

As a result, PMPS, the occurrence probability of a MPS, and PLPS, the occurrence probability of a LPS, within a range ivlCurrRange may be defined as in FIG. 13.

In an example shown in FIG. 13, the occurrence probability of a MPS and the occurrence probability of a LPS may be defined as in Equation 11.

$$MPS Occurence Probability = {P}_{M P S} / ivlCurrRange LPS Occurence Probability = {P}_{LPS} / ivlCurrRange \qquad [ Equation 11 ]$$

In this case, the sum of an occurrence probability of a MPS and an occurrence probability of a LPS may be 1 (i.e., 100%). As an example, it is assumed that a MPS is 1 (i.e., the value of valMPS is 1) and the value of ivlCurrRange is 200. When PMPS and PLPS are 140 and 60, respectively, the occurrence probability of 1 (i.e., a MPS) may be 70% and the occurrence probability of 0 (i.e., a LPS) may be 30%.

Afterwards, a variable ivlOffset is derived from a bitstream and a variable ivlCurrRange is updated. A variable ivlCurrRange may be updated to a value obtained by subtracting ivlLpsRange from a variable ivlCurrRange, i.e., the same value as ivlMpsRange.

FIG. 14 shows an example in which a variable ivlCurrRange is updated to be the same as a variable ivlMpsRange.

Then, the size of a variable ivlOffset is compared with the size of a variable ivlCurrRange.

If a variable ivlOffset is greater than or equal to a variable ivlCurrRange, ivlOffset may be determined to belong to the range of a LPS (i.e., ivlLpsRange). Otherwise, a variable ivlOffset may be determined to belong to the range of a MPS (i.e., ivlMpsRange).

According to the result, when a variable ivlOffset is determined to belong to a LPS section, a value set as a LPS may be output as the value of a bin (i.e., a variable binVal). On the other hand, when ivlOffset belongs to a MPS section, a value set as a MPS may be output as the value of a bin (i.e., a variable bin Val).

When a variable ivlOffset belongs to a MPS section, the value of a variable ivlCurrRange remains the same. On the other hand, when a variable ivlOffset belongs to a LPS section, a variable ivlCurrRange may be updated to a variable ivlLpsRange.

Similarly, when a variable ivlOffset belongs to a LPS section, the value of a variable ivlOffset may also be updated.

After the value of a bin is determined, probability update is performed. Specifically, a first probability state index pStateIdx0 and a second probability state index pStateIdx1 which represent the occurrence probability of 1 may be updated at different speed by the value of a decoded bin (i.e., binVal) and a variable adjusting update speed.

After probability update is performed, a renormalization process may be performed.

FIG. 15 is a flowchart showing a renormalization process.

As in an example shown in FIG. 15, a variable ivlCurrRange is compared with a predefined constant 256. When a variable ivlCurrRange is greater than or equal to 256, renormalization may not be performed.

Otherwise, a variable ivlCurrRange and a variable ivlOffset may be updated. In FIG. 15, read_bits (1) represents that 1 bit is read from a bitstream and output.

FIG. 16 represents a decoding process based on a bypass coding engine.

As in an example shown in FIG. 16, the value of a bin (i.e., binVal) may be determined by determining the value of a variable ivlOffset and a variable ivlCurrRange. When the value of a bin is 1, a variable ivlCurrRange may be updated to a value obtained by subtracting a variable ivlOffset. On the other hand, when the value of a bin is 0, a variable ivlCurrRange may not be updated.

In a bypass coding engine, probability information is not used. In other words, when a bypass coding engine is applied, the occurrence probability of 0 or the occurrence probability of 1 is not defined and the value of a bin may be encoded/decoded. In other words, when a bypass coding engine is used, the occurrence probability of 0 and the occurrence probability of 1 may be set as the same value.

When a bypass coding engine is used, the number of bins are the same as the number of bits.

According to the characteristic, a bypass coding engine is used for information that a probability setting is meaningless. In addition, a bypass coding engine is not mainly aimed at improving encoding/decoding efficiency due to entropy coding, but is mainly aimed at improving throughput, i.e., a processing rate.

Hereinafter, based on the above-described description, a method for encoding/decoding a motion vector difference value will be described in detail.

A motion vector difference value represents a difference between a motion vector and a motion vector prediction value. In other words, an encoder may derive a motion vector difference value by subtracting a motion vector prediction value from a motion vector and encode and signal a motion vector difference value. A decoder may decode a motion vector difference value from a bitstream and derive a motion vector by combining a motion vector difference value and a motion vector prediction value.

Meanwhile, a motion vector difference value may be encoded/decoded by using a bypass coding engine. Specifically, each of an absolute value and a sign of a motion vector difference value may be encoded by using a bypass coding engine.

A motion vector difference value MVD may be composed of a horizontal component MVD_x and a vertical component MVD_y. A method for encoding/decoding a motion vector difference value described in the following embodiments may represent a method for encoding/decoding the horizontal component of a motion vector difference value and a method for encoding/decoding the vertical component of a motion vector difference value. In other words, in embodiments described below, a motion vector difference value may correspond to at least one of the horizontal component of a motion vector difference value or the vertical component of a motion vector difference value.

In encoding a motion vector difference value, the absolute value |MVD| of a motion vector difference value and the sign of a horizontal component may be encoded. Meanwhile, the sign of a horizontal component may be encoded only when the absolute value |MVD| of a motion vector difference value is not 0.

The absolute value |MVD| of a motion vector difference value may be binarized in a fixed-length (FL) method. As an example, when it is assumed that the maximum value of an absolute value |MVD| of a motion vector difference value is 127, the absolute value |MVD| of a motion vector difference value may be binarized as in Table 1 below.

TABLE 1

| value of \|MVD\| | Binarization |
|---|---|
| 0 | 0000000 |
| 1 | 0000001 |
| 2 | 0000010 |
| 3 | 0000011 |
| 4 | 0000100 |
| 5 | 0000101 |
| 6 | 0000110 |
| 7 | 0000111 |
| . . . | . . . |
| 127 | 1111111 |

As in an example of Table 1, the absolute value of a motion vector difference value may be expressed as a bin string composed of 7 bins. In this case, each of 7 bins may be encoded by using a bypass coding engine.

However, as described above, a bypass coding engine has lower encoding/decoding efficiency than a general coding engine. In order to solve the problem, the present disclosure proposes an encoding/decoding method using context information in encoding/decoding the absolute value of a motion vector difference value, i.e., an encoding/decoding method using a general coding engine.

FIGS. 17 and 18 are a flowchart of a method for encoding/decoding a motion vector difference value according to an embodiment of the present disclosure.

FIG. 17 shows an operation in a decoder and FIG. 18 shows an operation in an encoder.

In encoding/decoding the absolute value of a motion vector difference value, a bypass coding engine may not be applied to at least one of the bins constructing a bin string. In this case, a decoder may decode only a bin string encoded by using a bypass coding engine among the bin strings corresponding to the absolute value of a motion vector difference value from a bitstream S1710.

For a bin encoded without using a bypass coding engine, a plurality of motion vector difference value candidates may be derived by considering a bin value that may be applied to a corresponding bin S1720.

As an example, when the absolute value |MVD| of a motion vector difference value is 126, a bin string corresponding to 126, the absolute value of a motion vector difference value, is 1111110. When it is assumed that a bypass coding engine is not applied to the last bin of the 7 bins (i.e., a Least Significant Bin (LSB)), a decoder may obtain 6 bin strings (i.e., ‘111111’) excluding a LSB from a bitstream.

Afterwards, a decoder may derive 2 motion vector difference value candidates by assuming a case in which the value of a last bin is 0 and a case in which it is 1. In other words, a first motion vector difference value candidate with an absolute value of 126 (i.e., a bin string 1111110) may be derived by assuming a case in which the value of a last bin is 0, and a second motion vector difference value candidate with an absolute value of 127 (i.e., a bin string 1111111) may be derived by assuming a case in which the value of a last bin is 1.

For convenience of a description, a bin that does not use a bypass coding engine is called an empty bin.

Meanwhile, the sign of motion vector difference value candidates may follow the sign of a motion vector difference value decoded from a bitstream.

Afterwards, a reference template may be set based on each motion vector difference value candidate S1730.

Specifically, as in an example shown in FIG. 19, a motion vector (or, a motion vector candidate) may be derived by combining a motion vector difference value candidate and a motion vector prediction value. Then, based on a motion vector, the position of a reference block in a reference picture may be determined and a pre-reconstructed region around a reference block may be set as a reference template.

FIG. 20 represents an example in which a reference template is derived based on a motion vector derived by combining a motion vector difference value candidate and a motion vector prediction value.

As in an example described above, when there are two motion vector difference value candidates, up to two reference templates may be derived.

A reference template may be a region having the same size and/or shape as a current template. As an example, in FIG. 20, it was shown that a template (i.e., a current template and a reference template) is configured by including top and left reconstructed regions of a block. Unlike a shown example, a template may be configured to include only the top region of a block or may be configured to include only the left reconstructed region of a block.

Alternatively, the configuration of a template may be adaptively determined according to the position of a reference block. As an example, when the top-left position of a reference block indicated by a motion vector is out of the top boundary of a picture or when a distance between the top-left position of a reference block and the top boundary of a picture is less than or equal to a threshold value, a template may be configured to include only a left reconstructed region. Alternatively, when the top-left position of a reference block indicated by a motion vector is out of the left boundary of a picture or when a distance between the top-left position of a reference block and the left boundary of a picture is less than or equal to a threshold value, a template may be configured to include only a top reconstructed region.

Alternatively, according to the position of a reference block, a motion vector difference value candidate may be set to be unavailable. As an example, when a motion vector is out of at least one of the top boundary or the left boundary of a picture, a corresponding motion vector difference value candidate may be determined to be unavailable.

When a reference template is set by a motion vector, a template matching cost between a current template and a reference template may be calculated S1740. Here, a template matching cost may be a Sum of Absolute Difference (SAD) between a current template and a reference template.

The value of a bin corresponding to an empty bin in a bin string for a motion vector difference value candidate used to derive a reference template having the smallest template matching cost among a plurality of reference templates may be set as the prediction value of an empty bin S1750.

As an example, when a template matching cost based on a second motion vector difference value candidate of a first motion vector difference value candidate with an absolute value of 126 (i.e., 1111110) and a second motion vector difference value candidate with an absolute value of 127 (i.e., 1111111) is smaller than a template matching cost based on a first motion vector difference value candidate, the empty bin of a bin string (1111111) corresponding to a second motion vector difference value candidate, i.e., a value corresponding to a LSB, may be set as the prediction value of an empty bin. Specifically, since the LSB of a bin string of a second motion vector difference value candidate has a value of 1, the prediction value of an empty bin may be set as 1.

Afterwards, the motion vector difference value of a current block may be determined based on information representing whether the prediction value of an empty bin decoded from a bitstream is accurate S1760.

The information may represent whether the actual value of an empty bin is the same as the prediction value of an empty bin. Here, the actual value of an empty bin may represent a value when an empty bin is encoded by using a bypass coding engine.

Meanwhile, the information may be a 1-bit flag. As an example, when the absolute value of a motion vector difference value derived from an encoder is 126 and the absolute value of a motion vector difference value candidate selected based on a template matching cost is also 126, the flag may indicate a value of true (e.g., 1).

On the other hand, when the absolute value of a motion vector difference value derived from an encoder is 126, but the absolute value of a motion vector difference value candidate selected based on a template matching cost is 127, the flag may indicate a value of false (e.g., 0).

When the flag indicates true, the absolute value of a motion vector difference value of a current block may be derived by applying the prediction value of an empty bin as it is.

On the other hand, when the flag indicates false, the absolute value of a motion vector difference value of a current block may be derived by applying a value different from the prediction value of an empty bin.

Meanwhile, the information may be encoded/decoded by using a general coding engine. As an example, the information may be encoded/decoded by giving a higher probability to a side indicating that the prediction value of an empty bin is correct than a side not indicating the same.

An encoder obtains a prediction value for an empty bin in the same manner as a decoder. Specifically, based on a value that may be taken for an empty bin, a plurality of motion vector difference value candidates may be derived S1810, and a reference template may be set based on a plurality of motion vector difference value candidates S1820.

A cost may be calculated for each of a plurality of reference templates S1830. And then, a reference template with the smallest cost may be selected, and the value of an empty bin used to derive a corresponding reference template may be set as the prediction value of an empty bin S1840. Afterwards, an encoder may encode information representing the accuracy of a prediction value of an empty bin and a bin string to which a bypass coding engine is applied among the motion vector difference values S1850. A bin string excluding an empty bin is encoded by using a bypass coding engine, while information representing the accuracy of a prediction value of an empty bin may be encoded by using a general coding engine.

FIG. 21 illustrates an aspect of encoding/decoding the absolute value of a motion vector difference value.

When following a method proposed in the present disclosure, as in an example shown in FIG. 21, instead of encoding/decoding all of 7 bins by using a bypass coding engine, 6 bins may be encoded/decoded by using a bypass coding engine and 1 bin may be encoded/decoded by using a general coding engine.

For example, in an example shown in FIG. 21, a LSB position may be encoded/decoded by being indicated as a value of 0 or 1 according to whether the prediction value of a LSB position is correct.

In an example described above, it was assumed that the LSB of a bin string is set as an empty bin. Unlike an example described above, a bin at a different position from a LSB may be set as an empty bin. As an example, the first bin (i.e., MSB, Most Significant Bit) of a bin string may be set as an empty bin.

Alternatively, the position of an empty bin in a bin string may be adaptively determined based on at least one of the size/shape of a current block, motion vector precision or whether to perform bidirectional prediction. As an example, when the motion vector precision of a current block is greater than a threshold value, the LSB of a bin string may be set as an empty bin. On the other hand, when the motion vector precision of a current block is equal to or less than a threshold value, the MSB of a bin string may be set as an empty bin. A threshold value may be 1, ½, ¼ or

Meanwhile, according to the position of an empty bin, a probability value for encoding/decoding information representing the accuracy of a prediction value of an empty bin may be different. As an example, as an empty bin is closer to a MSB, a probability that the prediction value of an empty bin is correct may increase. On the other hand, as an empty bin is closer to an LSB, a probability that the prediction value of an empty bin is correct may decrease.

The position of an empty bin may be predefined in an encoder and a decoder. Alternatively, the position of an empty bin may be adaptively determined based on at least one of the precision of a motion vector or whether to perform bidirectional prediction.

In the above-described example, it was assumed that the number of empty bins in a bin string is 1. Unlike an example described, a plurality of bins may be set as an empty bin.

FIG. 22 represents an example in which a plurality of bins are set as an empty bin.

The number of motion vector difference value candidates may increase in proportion to the number of empty bins. As an example, the number of motion vector difference value candidates may be 2∧N, and in this case, N may represent the number of empty bins.

When it is assumed that the absolute value of a motion vector difference value of a current block is 126 (i.e., 1111110) and two LSBs are set as an empty bin as in an example shown in FIG. 22, four motion vector difference value candidates may be derived as follows.
1) 124 (1111100)
2) 125 (1111101)
3) 126 (1111110)
4) 127 (1111111)

Four motion vector difference value candidates may be used to derive four reference templates and select a reference template with the smallest cost among the four reference templates. Afterwards, the value of bins corresponding to two empty bins among the bin strings of a motion vector difference value candidate used to derive a reference template with the smallest cost among the four reference templates may be set as a prediction value for two empty bins.

As an example, when a reference template derived by using a motion vector difference value candidate having a value of 127 has the smallest cost, the prediction value of a first empty bin at the position of a LSB is set as 1 and the prediction value of a second empty bin at the left position of a LSB is also set as 1.

For each of a first empty bin and a second empty bin, information representing whether a prediction value is correct may be encoded/decoded. For a first empty bin, since a prediction value (1) does not match an actual value (0), the value of a flag for a first empty bin is set as 0. On the other hand, for a second empty bin, since a prediction value (1) matches an actual value (1), the value of a flag for a second empty bin is set as 1.

According to an example shown in FIG. 22, the absolute value of a motion vector difference value may be encoded/decoded with five bins using a bypass coding engine and two bins using a general coding engine.

Meanwhile, unlike an example shown in FIG. 22, two MSBs may also be set as empty bins. As an example, information representing the accuracy of a prediction value may be encoded/decoded for a first empty bin positioned at a MSB and a second empty bin positioned at the right position of a MSB.

When a plurality of bins are set as an empty bin, a plurality of empty bins do not have to exist at a consecutive position. As an example, when two bins are set as an empty bin, a first empty bin may be a LSB and a second empty bin may be a MSB.

After dividing a bin string into a plurality of regions, an empty bin may be set only for a specific region among a plurality of regions. As an example, when a bin string is generated by at least two binarization methods and is composed of a prefix and a suffix, an empty bin may be set only for a bin string corresponding to a suffix. Alternatively, conversely, an empty bin may be set only for a bin string corresponding to a prefix.

Alternatively, one empty bin may be set for each of a bin string corresponding to a prefix and a bin string corresponding to a bin string.

As described above, a motion vector difference value may include a horizontal component and a vertical component, and deriving the absolute value of a motion vector difference value by using a prediction value for an empty bin may be applied to at least one of a horizontal component and a vertical component.

As an example, when an empty bin is set for a horizontal component and an empty bin is not set for a vertical component, a plurality of motion vector difference value candidates may have the different value of a horizontal component, but have the same value of a vertical component.

Conversely, when an empty bin is not set for a horizontal component and an empty bin is set for a vertical component, a plurality of motion vector difference value candidates may have the same value of a horizontal component, but have the different value of a vertical component.

An empty bin may be set for a horizontal component and a vertical component, respectively. As an example, when one empty bin is set for a horizontal component and one empty bin is set for a vertical component, four motion vector difference value candidates may be derived. A candidate with the smallest template matching cost among the four motion vector difference value candidates may be selected to derive a prediction value for the empty bin of a horizontal component and a prediction value for the empty bin of a vertical component.

A bin representing the sign of a motion vector difference value may be set as an empty bin. In other words, encoding/decoding of a sign of a motion vector difference value may be omitted, and information representing whether the prediction value of a sign of a motion vector difference value matches an actual value, e.g., a flag, may be encoded/decoded.

As an example, when the absolute value of a motion vector difference value is 126 and encoding/decoding of a motion vector difference is omitted, two motion vector difference value candidates may be generated as follows.

$$1 ) + 126$$

$$2 ) - 126$$

When the cost of a reference template derived by using (−126) of the two candidates is smaller than the cost of a reference template derived by using (+126), the prediction value of a sign of a motion vector difference value may be set as a value indicating a negative number. An encoder may encode information representing whether the prediction value matches an actual sign, and a decoder may determine encoding of a motion vector difference value based on the information. Likewise, the information may be encoded/decoded by using a general coding engine.

When bidirectional prediction is applied to a current block, a motion vector difference value prediction method using an empty bin may be applied for at least one of a L0 direction or a L1 direction. In this case, when an empty bin is set for both a L0 direction and a L1 direction, a prediction value for empty bins may be set through bilateral matching.

For convenience of a description, it is assumed that the absolute value of a motion vector difference value for a L0 direction is 124 and the absolute value of a motion vector difference value for a L1 direction is 4. In addition, it is assumed that a LSB is set as an empty bin in both a L0 direction and a L1 direction.

In this case, two motion vector difference value candidates below may be derived for a L0 direction.
1) 124 (1111100)
2) 125 (1111101)

Similarly, two motion vector difference value candidates below may be derived for a L1 direction.
1) 4 (0000100)
2) 5 (0000101)

Since there are two motion vector candidates for each of a L0 direction and a L1 direction, there may be four L0 motion vector and L1 motion vector combinations.

After calculating a bilateral matching cost for each of the four motion vector combinations, a prediction value for empty bins may be derived based on a L0 motion vector difference value candidate and a L1 motion vector difference value candidate used to derive a motion vector combination with the smallest cost. As an example, when the bilateral matching cost of a L0 motion vector and a L1 motion vector derived by using (124, 5) among the combinations of a L0 motion vector difference value candidate and a L1 motion vector difference value candidate is the smallest, the prediction value of an empty bin (i.e., a LSB) for a L0 direction may be set as 0 and the prediction value of an empty bin (i.e., a LSB) for a L1 direction may be set as 1.

In this case, for a L0 direction, the prediction value of an empty bin matches an actual value, so the value of a flag may be set as 1 and encoded/decoded. On the other hand, for a L1 direction, the prediction value of an empty bin is different from an actual value, so the value of a flag may be set as 0 and encoded/decoded.

In the above-described embodiments, instead of omitting encoding/decoding of an empty bin, it was described that information representing whether the prediction value of an empty bin is correct is additionally encoded/decoded. According to the embodiment, there is an effect of encoding/decoding a bin that was encoded/decoded by using a bypass coding engine by using a general coding engine.

Unlike the above-described embodiments, encoding/decoding of information representing whether the prediction value of an empty bin is correct may be omitted, and the prediction value of an empty bin may be used as a result value as it is.

Meanwhile, information representing whether a method for encoding/decoding a motion vector difference value based on the prediction value of an empty bin is used may be encoded and signaled. The information may be a 1-bit flag, and may be encoded and signaled in the unit of a sequence parameter set, a picture header, a slice header or a block.

Alternatively, whether a method for encoding/decoding a motion vector difference value based on the prediction value of an empty bin is used may be determined based on at least one of the size/shape of a current block, motion vector precision or whether to perform bidirectional prediction.

As an example, it may be determined that a method for encoding/decoding a motion vector difference value based on the prediction value of an empty bin is used only when the motion vector precision of a current block is greater than or equal to a threshold value.

When embodiments described based on a decoding process or an encoding process are applied to an encoding process or a decoding process, it is included in a scope of the present disclosure. When embodiments described in predetermined order are changed in order different from a description, it is also included in a scope of the present disclosure.

The above-described embodiment is described based on a series of steps or flow charts, but it does not limit a time series order of the present disclosure and if necessary, it may be performed at the same time or in different order. In addition, each component (e.g., a unit, a module, etc.) configuring a block diagram in the above-described embodiment may be implemented as a hardware device or software and a plurality of components may be combined and implemented as one hardware device or software. As an example, the hardware device may include at least one of a processor for performing an operation, a memory for storing data, a transmitter for transmitting data and a receiver for receiving data.

The above-described embodiment may be recorded in a computer readable recoding medium by being implemented in a form of a program instruction which may be performed by a variety of computer components. The computer readable recoding medium may include a program instruction, a data file, a data structure, etc. solely or in combination.

In addition, according to the present disclosure, a computer readable recording medium storing a bitstream generated by the above-described encoding method may be provided. The bitstream may be transmitted by an encoding device and a decoding device may receive the bitstream to decode an image.

A hardware device which is specially configured to store and perform magnetic media such as a hard disk, a floppy disk and a magnetic tape, optical recording media such as CD-ROM, DVD, magneto-optical media such as a floptical disk and a program instruction such as ROM, RAM, a flash memory, etc. is included in a computer readable recoding medium. The hardware device may be configured to operate as one or more software modules in order to perform processing according to the present disclosure and vice versa.

### INDUSTRIAL AVAILABILITY

The present disclosure may be applied to a computing or electronic device that may encode/decode a video signal.

1. A method of decoding an image, the method comprising:
obtaining a motion vector difference value of a current block;
obtaining a motion vector of the current block based on the motion vector difference value; and
obtaining a prediction sample for the current block based on the motion vector,
wherein a current motion vector difference value is obtained based on information representing whether a prediction value for an empty bin in a bin string corresponding to the motion vector difference value is correct.

2. The method of claim 1, wherein bins excluding the empty bin in the bin string is decoded without using probability information.

3. The method of claim 2, wherein the information representing whether the prediction value for the empty bin is correct is decoded by using the probability information.

4. The method of claim 3, wherein an occurrence probability of a value representing that the prediction value is correct is higher than an occurrence probability of a value representing that the prediction value is not correct.

5. The method of claim 1, wherein a candidate having a smallest template matching cost among a plurality of motion vector difference value candidates is selected, and
wherein a value at a position corresponding to the empty bin in a bin string of a selected candidate is set as a prediction value of the empty bin.

6. The method of claim 5, wherein the plurality of motion vector difference value candidates include a first motion vector difference value candidate corresponding to a case in which a value of the empty bin in the bin string is 0 and a second motion vector difference value candidate corresponding to a case in which the value of the empty bin in the bin string is 1.

7. The method of claim 1, wherein the empty bin corresponds to a position of a least significant bit (LSB) or a most significant bit (MSB) of the bin string.

8. The method of claim 1, wherein a position of the empty bin in the bin string is adaptively determined based on at least one of a motion vector precision of the current block or whether a bilateral prediction is applied to the current block.

9. The method of claim 1, wherein when the information indicates that the prediction value is correct, a value at a position of the empty bin in the bin string is determined as a same value as the prediction value.

10. The method of claim 9, wherein when the information indicates that the prediction value is not correct, the value at the position of the empty bin in the empty string is determined as a value different from the prediction value.

11. A method of encoding an image, the method comprising:
obtaining a prediction sample for a current block based on a motion vector of the current block;
obtaining a motion vector difference value of the current block by subtracting a motion vector prediction value from the motion vector; and
encoding the motion vector difference value,
wherein encoding the motion vector difference value includes encoding information representing whether a prediction value for an empty bin in a bin string corresponding to the motion vector difference value is correct.

12. The method of claim 11, wherein bins excluding the empty bin in the bin string is encoded without using probability information.

13. The method of claim 12, wherein the information representing whether the prediction value for the empty bin is correct is encoded by using the probability information.

14. The method of claim 13, wherein an occurrence probability of a value representing that the prediction value is correct is higher than an occurrence probability of a value representing that the prediction value is not correct.

15. A computer readable recoding medium storing a bitstream generated by an image encoding method, wherein the image encoding method comprising:
obtaining a prediction sample for a current block based on a motion vector of the current block;
obtaining a motion vector difference value of the current block by subtracting a motion vector prediction value from the motion vector; and
encoding the motion vector difference value,
wherein encoding the motion vector difference value includes encoding information representing whether a prediction value for an empty bin in a bin string corresponding to the motion vector difference value is correct.
